(19) United States
(12) Patent Application Publication
(10) Pub. No.: US 2014/0361070 A1
(43) Pub. Date: Dec. 11, 2014

(54) SOLDER ALLOYS

(71) Applicant: The Research Foundation for The State University of New York, Binghamton, NY (US)

(72) Inventor: Junghyun Cho, Vestal, NY (US)

(21) Appl. No.: 14/296,692

(22) Filed: Jun. 5, 2014

Related U.S. Application Data
(60) Provisional application No. 61/831,504, filed on Jun. 5, 2013.

(51) Int. Cl. B23K 35/26; B23K 1/20

(52) U.S. Cl. CPC B23K 35/264; B23K 1/20
USPC 228/249; 420/577

(57) ABSTRACT

A solder comprising a bismuth matrix, between about 5-24% copper; and about 0.5-36% tin or antimony or zinc; having a solidus temperature of ≧271° C., a reflow temperature of ≦375° C., and at least one intermetallic composition precipitate comprising copper and at least one of tin, antimony and zinc substantially excluding bismuth formed within the solidus phase.

### CROSS REFERENCE TO RELATED APPLICATION

The present application claims benefit of priority from U.S. Provisional Patent Application No. 61/831,504, filed Jun. 5, 2013, the entirety of which is incorporated herein by reference in its entirety.

### FIELD OF THE INVENTION

The present invention relates to high temperature solder compositions and methods for use, and more particularly lead-free, bismuth solders.

### BACKGROUND OF THE INVENTION

Power electronics that operate at temperatures over 200° C. require die attach materials with higher performance compared to traditional solders and epoxy-based adhesives in order to operate reliably. As power dissipation of components increases and overall package size decreases, engineers must innovate to ensure components don't overheat. Devices that run cooler last longer. In addition, in advance of forecasted government mandates, there is a growing focus on developing high-melting point (HMP) solders that do not contain lead (Pb).

Solder alloys typically used for soldering of electronic parts are alloys which have a composition close to 60% Sn and a low melting temperature among alloys of Sn and Pb. In particular, a solder alloy having a eutectic composition of Sn63-Pb37 has a solidus temperature and a liquidus temperature which are both 183° C. By using this solder, there is little occurrence of cracks at the time of cooling of the solder, and because it has the lowest melting point among all solder alloys of Sn and Pb, there is little damage to electronic parts due to heat.

The compositions of conventional high-temperature solders used for internal soldering of electronic parts mainly have Pb as a main component and include Pb-10Sn (solidus temperature of 268° C. and liquidus temperature of 302° C.), Pb-5Sn (solidus temperature of 307° C. and liquidus temperature of 313° C.), Pb-2Ag-8Sn (solidus temperature of 275° C. and liquidus temperature of 346° C.), Pb-5Ag (solidus temperature of 304° C. and liquidus temperature of 365° C.), and the like.

In recent years, the toxicity of Pb has caused concern, and therefore so-called “lead-free solder” is being increasingly widely used. At present, widely used lead-free solders include Sn-3Ag-0.5Cu (solidus temperature of 217° C. and liquidus temperature of 220° C.), Sn-8Zn-3Bi (solidus temperature of 190° C. and liquidus temperature of 197° C.), Sn-2.5Ag-0.5Cu-1Bi (solidus temperature of 214° C. and liquidus temperature of 221° C.), and the like. These lead-free solders have a melting temperature which is close to 40° C. higher than that of a conventional eutectic Sn63-Pb37 solder alloy. See, JP 2005-72173 A; JP 2001-353590 A. While Bi—Ag alloys (including Sn, Cu, In, Sb, and/or Zn) have been used in solders, the resulting alloy tends to have low strength. US 20130121874 discloses a solder having >90% Bi, with 1-5% by mass Sn, and 0.5-5% Sb or Ag.

Solders used to join electronic parts to substrates are broadly divided into high-temperature solders (about 260° C. to 400° C.) and low- and middle-temperature solders (about 140° C. to 230° C.) based on their melting temperatures. Among them, as for low- and middle-temperature solders, Pb-free solders mainly containing Sn have already been practically used.

For example, Japanese Patent Kokai No. 11-077366 discloses a Pb-free solder alloy composition containing Sn as a main component, 1.0 to 4.0% by mass of Ag, 2.0% by mass or less of Cu, 0.5% by mass or less of Ni, and 0.2% by mass or less of P.

Japanese Patent Kokai No. 8-215880 discloses a Pb-free solder alloy composition containing 0.5 to 3.5% by mass of Ag, 0.5 to 2.0% by mass of Cu, and the balance Sn. On the other hand, high-temperature Pb-free solder materials also have been developed, for example,

Japanese Patent Kokai No. 2002-160089 discloses a Bi/Ag brazing filler material containing 30 to 80% by mass of Bi and having a melting temperature of 350 to 500° C.

Japanese Patent Kokai No. 2006-167790 discloses a solder alloy obtained by adding a binary eutectic alloy to a eutectic alloy containing Bi and by further adding an additive element thereto, and describes that this solder alloy is a quaternary or higher solder, that is, a multi-component solder, but it is possible to adjust its liquidus-line temperature and to reduce variations in composition.

Japanese Patent Kokai No. 2007-281412 discloses a solder alloy obtained by adding Cu—Al—Mn, Cu, or Ni to Bi, and describes that when such a solder alloy is used to join a power semiconductor device having a Cu surface layer to an insulator substrate having a Cu surface layer, an undesired reaction product is less likely to be formed at a joint interface between the solder and each of the Cu layers so that the occurrence of defects such as cracks can be suppressed.

Japanese Patent No. 3671815 discloses a solder composition containing, based on the total mass of the solder composition, 94.5% by mass or more of Bi as a first metal element, 2.5% by mass of Ag as a second metal element, and a total of 0.1 to 3.0% by mass of at least one selected from the group consisting of Sn: 0.1 to 0.5% by mass, Cu: 0.1 to 0.3% by mass, In: 0.1 to 0.5% by mass, Sb: 0.1 to 3.0% by mass, and Zn: 0.1 to 3.0% by mass as a third metal element.

Japanese Patent Kokai No. 2004-025232 discloses a Pb-free solder composition containing a Bi-based alloy containing at least one of Ag, Cu, Zn, and Sb as an accessory component and 0.3 to 0.5% by mass of Ni, and describes that this Pb-free solder has a solidus-line temperature of 250° C. or higher and a liquidus-line temperature of 300° C. or less. Japanese Patent Kokai No. 2007-181880 discloses a binary alloy containing Bi, and describes that this binary alloy has the effect of suppressing the occurrence of cracking in the inside of a soldering structure.

Japanese Patent Application Kokai No. 2007-313526 discloses a Bi alloy having a melting temperature of 271° C. or higher and containing 0.2 to 0.8% by mass of Cu and 0.2 to 0.02% by mass of Ge.

Japanese patent Application Kohyo No. 2004-533327 discloses a Bi alloy having a solidus-line temperature of at least 260° C. and containing 2 to 18% by mass of Ag. Japanese patent Application Kohyo No. 2004-528992 discloses a Bi alloy having a solidus-line temperature of 262.5° C. or higher and containing 82 to 98% by mass of Bi.

US 20040241039 discloses a high temperature solder alloy comprising Sn, Cu, Ag, Bi and Sb, in an amount of >90% Sn, 0.2-0.5% Cu, 0.05-5% Bi or >75% Sn, 0.5-7% Cu, 0.05-18% Sb, or >67% Sn, 3-15% Ag, and 0.01-18% Sb, or >78% Sn, 0.8-7% Cu, 4-15% Ag, or >96% Sn, 0.01-2% Zn or 0.01-2% Co, or >90% Sn, 0.05-5% Bi, and 0-5% Sb, or >90% Sn, 0.2-0.9% Cu, and 0.1-5% Bi.

U.S. Pat. No. 5,393,489 discloses solder alloys which contain >90% Sn, and an effective amount of Ag and Bi, optionally with Sb or with Sb and Cu. Another form of the alloy contains Ag and Sb, optionally with Bi.

U.S. Pat. No. 5,344,607 discloses a ternary solder alloy having a major portion of Sn and lesser portions of Bi and In.

U.S. Pat. No. 5,320,272 discloses a tin-bismuth alloy solder with a ternary metal (e.g., Au or Ag) in an amount effective to increase the melting temperature of the alloy and enhance mechanical properties of the connection at elevated temperatures typically encountered during operation.

U.S. Pat. No. 5,368,814 discloses a low solidus temperature solder having >50% Bi, <50% Sn (based on Bi+Sn), and Cu, In, Ag or Cu+Ag.

U.S. Pat. No. 5,393,489 discloses a high solidus temperature solder alloy having >90% Sn, and Ag and Bi, and optionally Sb or Sb+Cu, or >90% Sn and Ag+Sb and optionally Bi.

Each of the aforementioned references is expressly incorporated herein by reference in their entirety.

See also: U.S. Pat. Nos. 3,671,815; 3,945,556; 3,949,118; 4,042,725; 4,106,930; 4,170,472; 4,173,468; 4,193,530; 4,248,905; 4,357,162; 4,358,884; 4,374,904; 4,396,677; 4,491,562; 4,492,842; 4,512,950; 4,670,217; 4,695,428; 4,749,626; 4,758,407; 4,778,733; 4,797,328; 4,806,309; 4,834,794; 4,869,871; 4,879,096; 4,929,423; 4,937,006; 4,937,045; 5,011,658; 5,019,336; 5,039,576; 5,094,700; 5,094,813; 5,098,656; 5,102,748; 5,120,498; 5,147,471; 5,205,461; 5,229,070; 5,242,658; 5,244,143; 5,256,370; 5,286,417; 5,308,578; 5,314,758; 5,316,205; 5,320,272; 5,328,521; 5,328,660; 5,344,607; 5,352,407; 5,354,624; 5,361,966; 5,368,814; 5,382,300; 5,389,160; 5,393,489; 5,405,577; 5,410,184; 5,411,703; 5,414,303; 5,429,689; 5,432,998; 5,435,857; 5,435,968; 5,439,639; 5,455,004; 5,480,731; 5,487,868; 5,489,803; 5,520,752; 5,527,628; 5,538,686; 5,569,433; 5,573,602; 5,580,520; 5,586,715; 5,591,941; 5,593,082; 5,644,475; 5,653,856; 5,658,528; 5,672,542; 5,675,889; 5,690,890; 5,698,160; 5,726,501; 5,730,932; 5,733,501; 5,755,896; 5,759,379; 5,762,866; 5,766,776; 5,817,194; 5,833,921; 5,837,191; 5,838,069; 5,839,496; 5,843,371; 5,851,482; 5,863,493; 5,871,690; 5,874,043; 5,918,795; 5,928,404; 5,938,862; 5,942,185; 5,958,333; 5,980,822; 5,985,212; 5,993,736; 6,015,083; 6,033,488; 6,048,629; 6,077,477; 6,086,687; 6,096,245; 6,139,979; 6,156,132; 6,159,304; 6,165,885; 6,176,947; 6,179,935; 6,180,055; 6,180,264; 6,184,475; 6,187,114; 6,197,253; 6,204,490; 6,210,547; 6,220,501; 6,228,322; 6,229,248; 6,231,691; 6,241,942; 6,267,823; 6,296,722; 6,306,516; 6,313,412; 6,319,461; 6,319,617; 6,319,810; 6,325,279; 6,361,626; 6,361,742; 6,365,097; 6,367,683; 6,371,361; 6,403,233; 6,416,883; 6,428,745; 6,439,124; 6,440,360; 6,476,487; 6,488,888; 6,503,338; 6,504,105; 6,517,602; 6,521,176; 6,554,180; 6,555,052; 6,563,225; 6,585,149; 6,592,020; 6,592,943; 6,648,210; 6,649,127; 6,656,422; 6,659,329; 6,660,226; 6,669,077; 6,673,310; 6,689,488; 6,692,691; 6,702,176; 6,703,113; 6,705,509; 6,717,065; 6,726,780; 6,736,907; 6,740,544; 6,767,411; 6,774,490; 6,783,057; 6,805,974; 6,811,892; 6,812,570; 6,815,066; 6,818,839; 6,824,039; 6,837,947; 6,843,862; 6,849,805; 6,853,077; 6,854,636; 6,872,465; 6,881,278; 6,884,389; 6,893,512; 6,893,799; 6,902,102; 6,915,944; 6,926,849; 6,936,219; 6,960,396; 6,974,615; 6,984,254; 7,005,106; 7,005,745; 7,013,564; 7,022,282; 7,029,542; 7,037,559; 7,070,736; 7,074,627; 7,097,090; 7,111,771; 7,131,566; 7,132,020; 7,138,086; 7,148,426; 7,172,726; 7,175,804; 7,175,805; 7,176,388; 7,179,417; 7,215,030; 7,220,493; 7,241,348; 7,250,135; 7,259,465; 7,282,174; 7,282,175; 7,335,269; 7,338,567; 7,422,721; 7,425,299; 7,435,711; 7,472,473; 7,472,817; 7,473,580; 7,475,803; 7,488,445; 7,528,489; 7,537,728; 7,540,078; 7,572,343; 7,604,154; 7,628,308; 7,644,855; 7,658,538; 7,670,548; 7,681,777; 7,682,468; 7,709,746; 7,718,523; 7,722,962; 7,744,706; 7,749,336; 7,749,340; 7,750,475; 7,754,343; 7,758,916; 7,771,547; 7,772,115; 7,776,808; 7,793,820; 7,806,994; 7,829,199; 7,838,954; 7,859,107; 7,866,529; 7,879,455; 7,886,955; 7,901,782; 7,911,062; 7,964,492; 7,973,412; 8,001,683; 8,022,551; 8,034,195; 8,083,832; 8,091,766; 8,128,868; 8,138,606; 8,157,157; 8,197,612; 8,216,395; 8,220,692; 8,221,560; 8,227,536; 8,241,436; 8,283,783; 8,293,370; 8,303,735; 8,309,877; 8,344,522; 8,348,139; 8,388,724; 8,404,359; 8,411,455; 8,420,722; 8,448,838; RE29563; 20010000321; 20010018030; 20010025875; 20010036420; 20010048888; 20020009384; 20020012607; 20020012608; 20020015659; 20020015660; 20020040624; 20020051728; 20020057986; 20020106302; 20020114726; 20020117539; 20020127136; 20020131887; 20020150787; 20020155024; 20020159913; 20020192106; 20030003011; 20030003012; 20030007885; 20030007886; 20030021718; 20030021719; 20030091463; 20030095888; 20030133826; 20030143103; 20030143104; 20030156969; 20030175146; 20030178101; 20030189086; 20030230361; 20040052678; 20040062679; 20040096632; 20040112474; 20040115088; 20040126268; 20040126269; 20040126270; 20040141873; 20040151616; 20040156740; 20040156741; 20040170524; 20040187976; 20040208779; 20040241039; 20040258556; 20040262779; 20050008525; 20050031483; 20050036902; 20050069725; 20050079092; 20050100474; 20050106059; 20050106060; 20050147522; 20050260095; 20060013722; 20060024194; 20060045793; 20060067852; 20060067853; 20060088439; 20060088440; 20060104854; 20060104855; 20060113683; 20060147337; 20060193744; 20060204397; 20060210420; 20060222559; 20060239855; 20060263234; 20060263235; 20060285994; 20070036670; 20070036671; 20070048172; 20070051201; 20070059548; 20070071634; 20070092396; 20070122646; 20070125449; 20070128068; 20070134125; 20070172381; 20070178007; 20070227627; 20070228109; 20070243098; 20070286762; 20070295528; 20070297937; 20080026240; 20080042111; 20080061117; 20080070059; 20080110609; 20080118761; 20080131309; 20080142124; 20080159903; 20080159904; 20080175748; 20080241552; 20080292492; 20080292493; 20090014746; 20090098012; 20090104071; 20090129970; 20090129971; 20090166876; 20090196789; 20090197103; 20090208363; 20090232696; 20090242249; 20090286093; 20090289102; 20090304545; 20100015004; 20100031848; 20100059576; 20100092335; 20100159257; 20100189594; 20100203353; 20100233018; 20100272598; 20100294550; 20100294565; 20100296965; 20100297470; 20100307823; 20110064604; 20110089224; 20110091351; 20110108996; 20110110813; 20110115084; 20110180311; 20110182041; 20110198755; 20110204121; 20110274937; 20110303448; 20120038042; 20120175020; 20120193800; 20120280593; 20120321506; 20120328361; 20130037314; 20130078138; 20130094991; 20130121874; 20130121874; each of which is expressly incorporated herein by reference.

See also:

H. Schoeller, S. Bansal, A. Knobloch, D. Shaddock, and J. Cho, “Effect of Alloying Elements on the Creep Behavior of High Pb Based Solders,” Materials Science and Engineering A, 528, 1063-1070 (2011).

H. Schoeller, S. Bansal, A. Knobloch, D. Shaddock, and J. Cho, “Microstructure Evolution and the Constitutive Relations of High-Temperature Solders,” Journal of Electronic Materials, 38 [6] 802-809 (2009).

### SUMMARY OF THE INVENTION

The present technology provides a high temperature solder with superior mechanical and acceptable thermal transfer properties comprising principally bismuth in a ternary alloy.

This breakthrough alloy can replace high-lead (Pb) materials that currently dominate high temperature electronics applications. High-tin (Sn) solders inherently do not work over 200° C. due to their approaching too closely their melting points. Other solders such as hard Au-containing solders are expensive and are susceptible to thermal fatigue failure.

A particular improvement of the current technology is based on the high melting temperature of Bi, and alloying it with other metals to overcome drawbacks of pure Bi such as brittleness, low thermal conductivity and poor wetting to metallized surfaces. The ternary alloys according to the present technology have uniquely designed microstructures well suited for die attach materials operating in high temperature and mechanically stressful environments where reliability is critical.

According to one aspect of the invention, the solder is alloyed with copper, which acts to improved thermal transfer and mechanical properties. In addition, intermetallic nanoparticles may also form in situ within the solder, to provide advantageous properties including high temperature capabilities.

The alloys preferably have operating temperatures for products including the solder above about 271° C., and having a solder reflow temperature above about 290° C. to 375° C.

The alloys are preferably lead free, but in some cases may include lead either as an impurity or as an intentional component. Lead solders provide a model for determining properties and the effects of changes in microstructure on properties, and therefore the study of these alloy systems is useful. The exclusion of lead in solders is typically an issue of environmental consequence of disposal, and therefore lead can be used in some cases where this issue is less critical, or otherwise acceptable.

The solder alloys preferably have good wetting on bonding surfaces such as nickel and copper.

The solder alloys also preferably have superior thermal and electrical conductivity. For example, a copper-rich phase, and/or copper-containing intermetallic phase within the bismuth matrix, may assist in achieving these properties.

The solder alloys preferably contributes to optimal mechanical properties to the package, for example die attachments of a power semiconductor package.

Further, the solder alloys may exclude gold and silver as critical components, and thus provide a lower-cost alternative to expensive die attach materials such as hard solders (Au—Sn) and nano-silver.

The solders may be used for die attachments for semiconductors and especially power semiconductors, e.g., III-V power semiconductors or SiC semiconductors which may have high operating temperatures, as a joining material for high temperature electronics used in automotive systems, such as power control, especially in electric vehicles and hybrids, downhole drilling and other high ambient/operating temperature applications, and aerospace sectors. The solders may facilitate optical computing and power laser integration into systems, especially where the laser experiences high peak temperatures.

According to one aspect of the technology, a solder is provided comprising Bismuth, at least 5% by mass copper (e.g., 5-24% Cu), and about 5% tin by weight (e.g., 4-15% Sn), which remains solid at a temperature above about 271° C. For example, compositions represented by the range above c-d in FIG. 27. An example alloy is Bi-14Cu-8Sn. More generally, the alloy may be expressed as Bi-(8 to 15)Cu-(10 to 5)Sn.

According to another aspect of the technology, a solder is provided comprising Bismuth, at least 7% copper (e.g., 7-20%), and about 10% zinc by weight which remains solid above about 271° C. For example, compositions represented by the range above c-d in FIG. 28. An example alloy is Bi-16Cu-10Zn.

According to another aspect of the technology, a solder is provided comprising Bismuth, at least 9% antimony (e.g., 9-25% Sb), and about 10% copper by weight which remains solid above about 271° C. for 9% Sb or above about 300° C. for 25% Sb. For example, compositions represented by the range above c-d in FIG. 29. An example alloy is Bi-20Sb-10Cu.

It is therefore an object to provide a solder comprising: between about 5-24% copper; about 4-25% tin or antimony or zinc; and at least 50% by weight bismuth, having a solidus temperature of ≧271° C., a reflow temperature of ≦375° C., and at least one intermetallic composition precipitate comprising copper and at least one of tin, antimony and zinc substantially excluding bismuth formed within the solidus phase.

It is a further object to provide a ternary bismuth alloy comprising: at least 50% bismuth; 5-24% copper; and 4-25% tin or antimony or zinc, having: a solidus temperature of ≧271° C., a liquidus temperature of ≦660° C., and comprising copper intermetallic composition nanoparticles having a hardness greater than the bismuth matrix comprising at least one of tin, antimony and zinc formed within the solidus phase, having a thermal conductivity greater than pure bismuth.

It is a still further object to provide a soldering method, comprising: providing two respective surfaces, e.g., metallic surfaces adapted to be wet by bismuth or a bismuth alloy, separated by a gap; placing a ternary bismuth alloy having a solidus temperature of ≧271° C. within the gap, comprising at least 50% bismuth, 5-24% copper, and 4-25% tin or antimony or zinc, forming at least one intermetallic composition precipitate comprising copper and at least one of tin, antimony and zinc substantially excluding bismuth formed within a solidus phase; heating the ternary bismuth alloy to a temperature above the solidus temperature, to melt at least the bismuth matrix phase of the ternary bismuth alloy, and wet the respective surfaces with the ternary bismuth alloy; and reducing the temperature of the ternary bismuth alloy to below the solidus temperature, to solidify the ternary bismuth alloy and thereby join the two metals. The soldered joint preferably has an operating temperature of up to 271° C. The at least one intermetallic composition precipitate comprising copper and at least one of tin, antimony and zinc substantially excluding bismuth formed within the solidus phase preferably comprises copper intermetallic composition nanoparticles having a hardness greater than the bismuth matrix surrounding the nanoparticles, and a thermal conductivity greater than pure bismuth. The ternary bismuth alloy has a liquidus temperature ≦660° C., but a complete melting is not required for good bonding as long as the bismuth matrix is completely melted (i.e., above the solidus line).

The ternary bismuth alloy solder may comprise Bi-xCu-8Sn, where x=8-21, and preferably 78Bi-14Cu-8Sn.

The ternary bismuth alloy solder may comprise Bi-xCu-10Zn, where x=8-21, and preferably 74Bi-16Cu-10Zn.

The ternary bismuth alloy solder may comprise Bi-xSb-10Cu, where x=9-36, and preferably 70Bi-20Sb-10Cu.

Once reflowed into the joined area between the die and the substrate, a thermal conductivity of the solder according to the present technology becomes greater than the corresponding bulk bismuth solders and comparable to high-Pb based solders. The bonded dies using these solder alloys have a shear strength comparable to high-Pb based solders and one commercially available Bi solder.

### BRIEF DESCRIPTION OF THE DRAWINGS

FIGS. 1A-1F show microstructure features of lead-based high temperature alloys, FIG. 1A 90Pb-10Sn, FIG. 1B 90Pb-2Sn, FIG. 1C 90Pb-3Sb, FIG. 1D 90Pb-5In, FIG. 1E 85Pb-10Sb-5Sn, and FIG. 1F 92.5Pb-5Sn-2.5Ag. Second phase precipitates are shown in FIGS. 1A, 1B and 1C. Solid solution strengthening is shown in FIGS. 1A and 1D. Duplex microstructure (superplastic deformation) is shown in FIG. 1E. A high temperature intermetallic composition (IMC) is shown in FIG. 1F.

FIG. 2 shows an expanded detail of FIG. 1F.

FIG. 3 shows indium rich band formation in Pb-5In-2.5Ag in an as-cast form.

FIG. 4 shows microstructure features of Pb-5In-2.5Ag after annealing at 250° C.

FIG. 5 shows an EDS (Energy Dispersive X-ray Spectrometry) study of Pb-5In-2.5Ag, showing an indium enriched band formation which is not seen in the corresponding alloy Pb-5Sn-2.5Ag (see FIG. 1F).

FIG. 6 shows the elastic modulus of various Pb solder alloys as a function of temperature, and Sn-5Sb.

FIG. 7 shows the ultimate tensile strength of various Pb solder alloys as a function of temperature, and Sn-5Sb.

FIG. 8 shows the stress-strain relationship at 200° C. of various Pb solder alloys as a function of temperature, and Sn-5Sb.

FIG. 9 shows the stress-dependence of creep for various high Pb solder alloys, segregated into regions of Harper-Dorn creep, viscous drag, and dislocation creep controlled by dislocation climb, at 100° C.

FIG. 10 shows the normalized stress versus temperature for high Pb solder alloys, segregates into regions of viscous drag, dislocation creep (lattice diffusion), dislocation creep (core diffusion), and power-law breakdown with a strain rate of ˜10⁻⁶ to 10⁻³/s.

FIGS. 11-12 show the microstructure of Pb-3Sn, showing β-Sn phases in a Pb matrix.

FIGS. 13-14 shows a nano-deformation test of the Pb matrix and β-Sn phases of Pb-3Sn.

FIGS. 15-16 show the microstructure of Pb-3Sb, showing β-Sb phases in a Pb matrix.

FIGS. 17-18 shows a nano-deformation test of the Pb matrix and β-Sb phases of Pb-3Sb.

FIGS. 19-20 show the microstructure of Pb-3In, revealing no apparent β-In phase in the Pb matrix.

FIG. 21 shows a nano-deformation test of the Pb matrix of Pb-3In.

FIGS. 22-23 show the microstructure of Pb-5In-2.5Ag, showing Ag₉In₄ phases in a Pb-band.

FIGS. 24-25 shows a nano-deformation test of the Pb band and Ag₉In₄ phases of Pb-5In-2.5Ag.

FIG. 26 shows a ternary phase diagram of Bi—Sn—Su at 271° C., indicating the Bi-14Cu-8Sn composition (X mark).

FIG. 27 shows a phase diagram versus temperature of Bi-xCu-8Sn over a range of 0-20% Cu.

FIG. 28 shows a phase diagram versus temperature of Bi-xCu-10Zn over a range of 0-21% Cu.

FIG. 29 shows a phase diagram versus temperature of Bi-xSb-10Cu over a range of 0-36% Sb.

FIGS. 30A and 30B show reaction of Bi-14Cu-8Sn and Bi-20Sb-10Cu solders at 350° C. with Ni.

FIGS. 31 and 32 show equilibrium fractions of phases in Bi—Cu—Sn, as a function of temperature for Bi-14Cu-8Sn and Bi-20Cu-8Sn.

FIGS. 33-36 show optical microscopy (FIGS. 33-35) and scanning electronic microscopy (FIG. 36) images of the microstructure of 78Bi-14Cu-8Sn.

FIG. 37 shows a ternary phase diagram of Bi—Cu—Sb at 290° C., indicating the Bi-20Sb-10Cu composition (X mark).

FIGS. 38 and 39 show equilibrium fractions of phases in Bi—Sb—Cu, as a function of temperature for Bi-20Sb-10Cu and Bi-25Sb-5Cu.

FIGS. 40-43 show optical microscopy (FIGS. 40-42) and scanning electronic microscopy (FIG. 43) images of the microstructure of 70Bi-20Sb-10Cu.

FIGS. 44 and 45 show load vs. displacement diagrams for the BiSbCu matrix and intermetallic compositions for 70Bi-20Sb-10Cu.

FIGS. 46A-46E show a reaction of silicon (with backside metallization of Ti/Ni/Au) and 78Bi-14Cu-8Sn on copper.

FIGS. 47A-47D shows a reaction of silicon (with backside metallization of Ti/Ni/Au) and 70Bi-20Sb-10Cu on copper.

FIG. 48 shows a graph comparing thermal conductivity of as-cast 78Bi-14Cu-8Sn and 70Bi-20Sb-10Cu bulk solders, and Bi. Pure Bi data is from the reference (CRC Handbook of Chemistry and Physics, 2007).

FIG. 49 shows a graph comparing thermal conductivity of the 70Bi-20Sb-10Cu die attach (bond line thickness of 329 μm), the 70Bi-20Sb-10Cu die attach (bond line thickness of 150 μm), and the as-cast 70Bi-20Sb-10Cu bulk solder. These data are compared with that of pure Bi, pure Sb, and high-Pb solder (Pb-5Sn).

FIG. 50 shows die shear testing results for the 70Bi-20Sb-10Cu solder reflowed at 330, 350, and 370° C. to bond the die to the Cu substrate, compared with those from high-Pb solder and one commercially available Bi solder.

### DETAILED DESCRIPTION OF THE PREFERRED EMBODIMENTS

Table 1 shows properties of various high temperature solders:

TABLE 1
High Temperature Solder Alloys

| | | | | Liquidus | Solidus | | |
|---|---|---|---|---|---|---|---|
| Solder Alloys | | | | Temp (° C.) | Temp (° C.) | Notes | |
| 95Sn | 5Sb | | | 240 | 235 | Pb-free | process temp >300° C., |
| | | | | | | solder | not compatible for >200° C. |
| 90Sn | 10Sb | | | 272 | 250 | Pb-free | process temp >300° C., |
| | | | | | | solder | not compatible for >200° C. |
| 85Pb | 10Sb | 5Sn | | 255 | 245 | Superplastic | Process temp >350° C., |
| | | | | | | Alloy | environmental concerns |
| 90Pb | 10Sn | | | 301 | 268 | Single phase | Process temp >350° C., |
| | | | | | | above | environmental concerns |
| | | | | | | 135° C. | |
| 92.5Pb | 5Sn | 2.5Ag | | 296 | 287 | β-Sn, IMC | Process temp >350° C., |
| | | | | | | | environmental concerns |
| 93Pb | 3Sn | 2Ag | 2In | 304 | — | β-Sn, IMC, | Process temp >350° C., |
| | | | | | | solid | environmental concerns |
| | | | | | | solution | |
| 92.5Pb | 5In | 2.5Ag | | 310 | 300 | IMC, solid | Process temp >350° C., |
| | | | | | | solution | environmental concerns |
| 95Pb | 5In | | | 313 | 300 | Single phase | Process temp >350° C., |
| | | | | | | alloy | environmental concerns |
| 97Pb | 3Sb | | | 320 | 300 | β-Sb | Process temp >350° C., |
| | | | | | | | environmental concerns |
| 97Pb | 3In | | | 320 | 315 | Single phase | Process temp >350° C., |
| | | | | | | alloy | environmental concerns |
| 97Pb | 3Sn | | | 321 | 315 | β-Sn | Process temp >350° C., |
| | | | | | | | environmental concerns |
| 78Bi | 14Cu | 8Sn | | | 271 | | Cast ingot DSC melting |
| | | | | | | | temp. 271° C. |
| 70Bi | 20Sb | 10Cu | | | 294 | | Cast ingot DSC melting |
| | | | | | | | temp. 280° C. |
| 74Bi | 16Cu | 10Zn | | | 271 | | |

(IMC = intermetallic compound).

As shown in Table 1, the lead free 95Sn-5Sb falls at the lower end of the high temperature solders, and would generally be unusable at temperatures above 250° C. The lead solders have higher operating temperatures, but lead raises toxicity issues both during manufacturing and at the end of the service life of components.

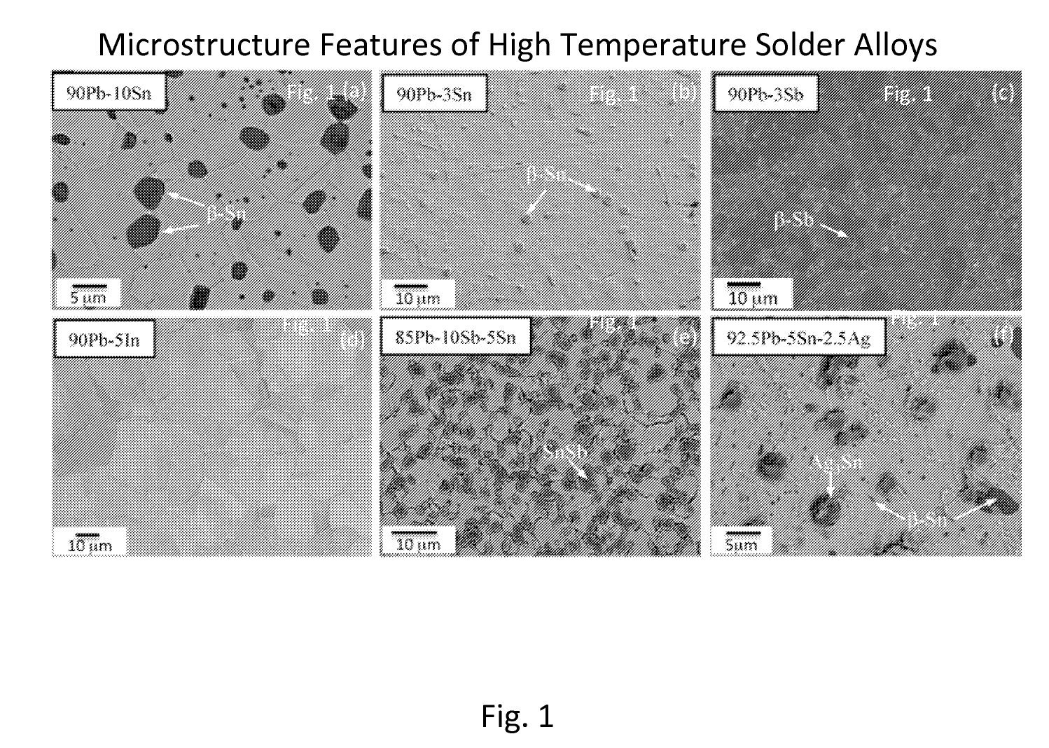

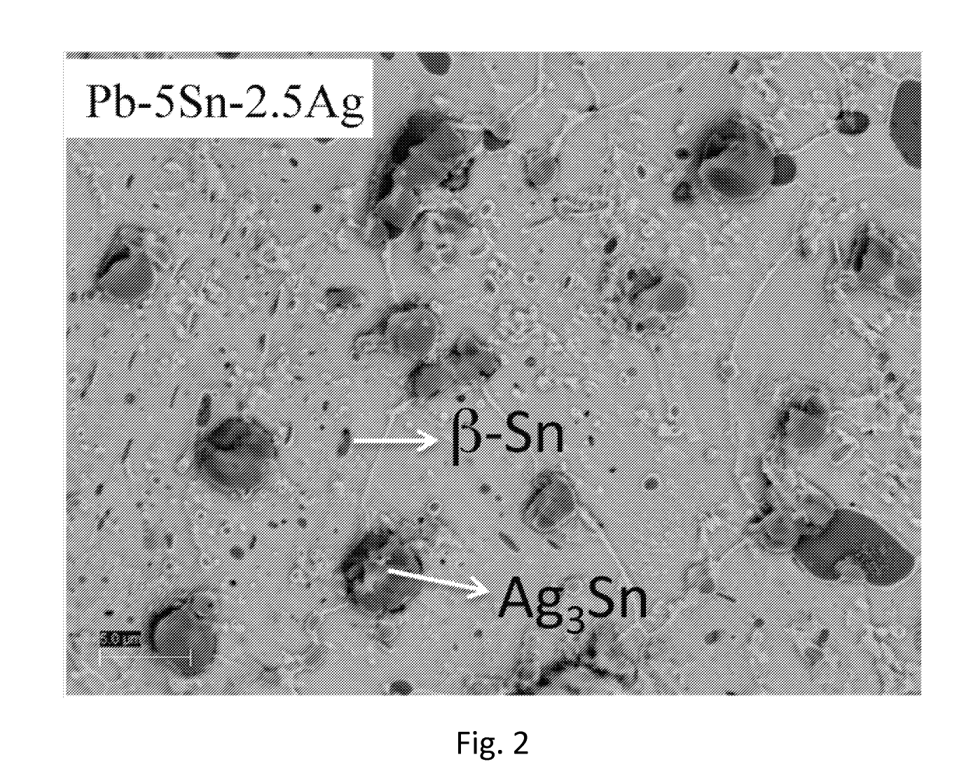

FIGS. 1A-1F show microstructure features of various lead-based high temperature solders. FIG. 1A shows 90Pb-10Sn. FIG. 1B shows 90Pb-3Sn. FIG. 1C shows 90Pb-3Sb. FIG. 1D shows 90Pb-5In. FIG. 1E shows 85Pb-10Sb-5Sn. FIGS. 1F and 2 show 92.5Pb-5Sn-2.5Ag. FIGS. 1A, 1B and 1C show second phase precipitates. FIGS. 1A and 1D show solid solution strengthening. FIG. 1E shows a duplex microstructure (superplastic deformation). FIG. 1F shows high temperature intermetallic compounds.

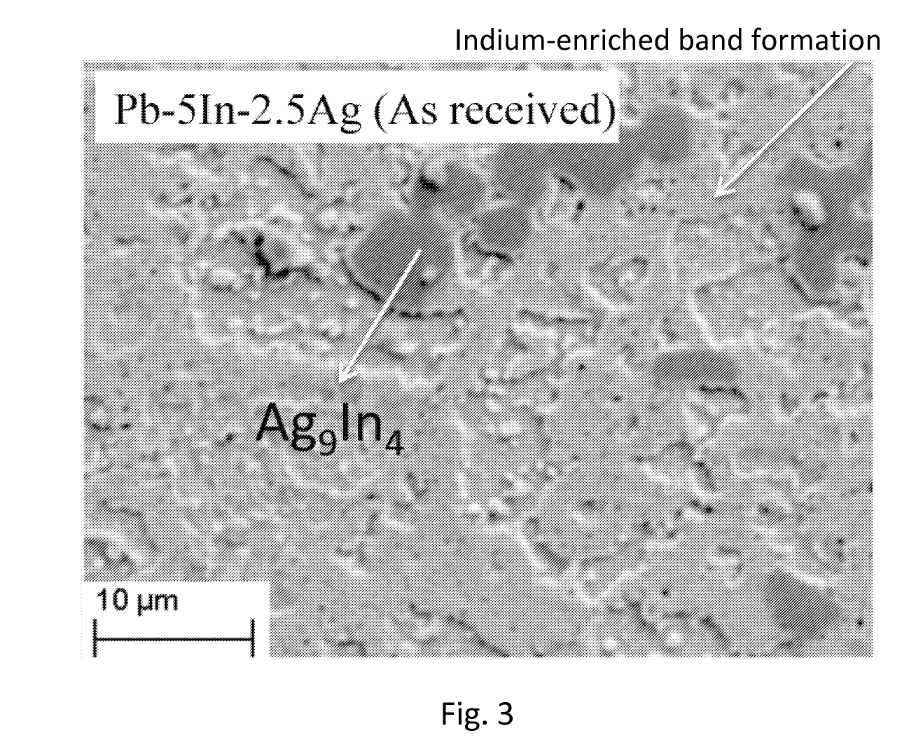

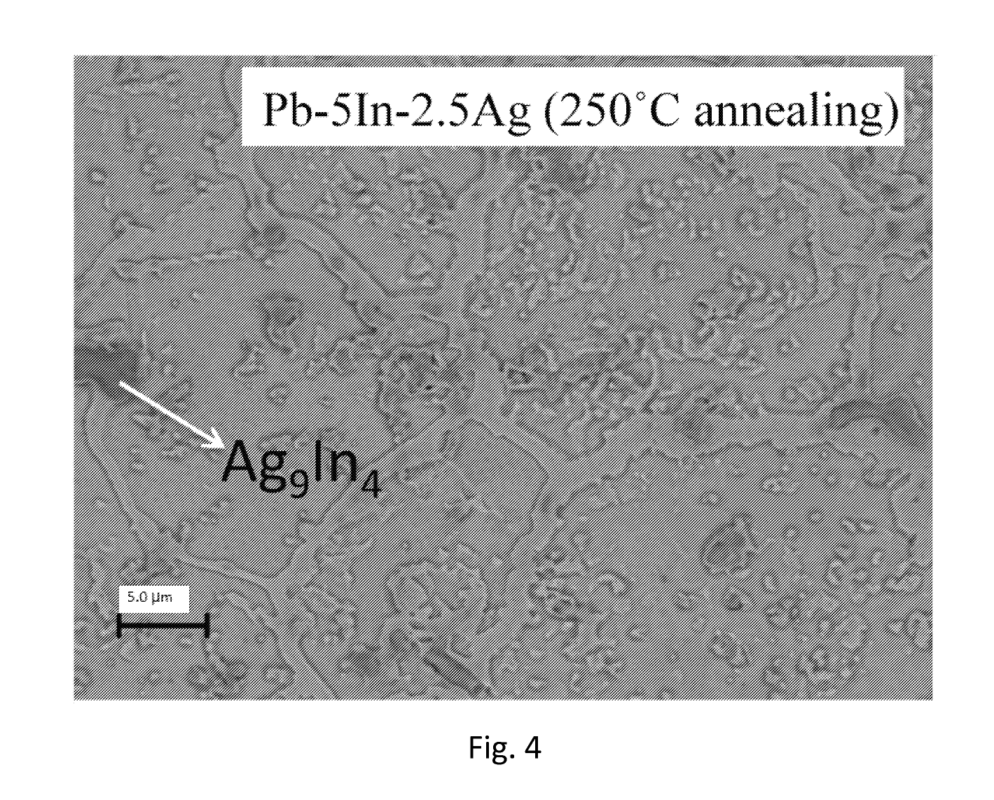

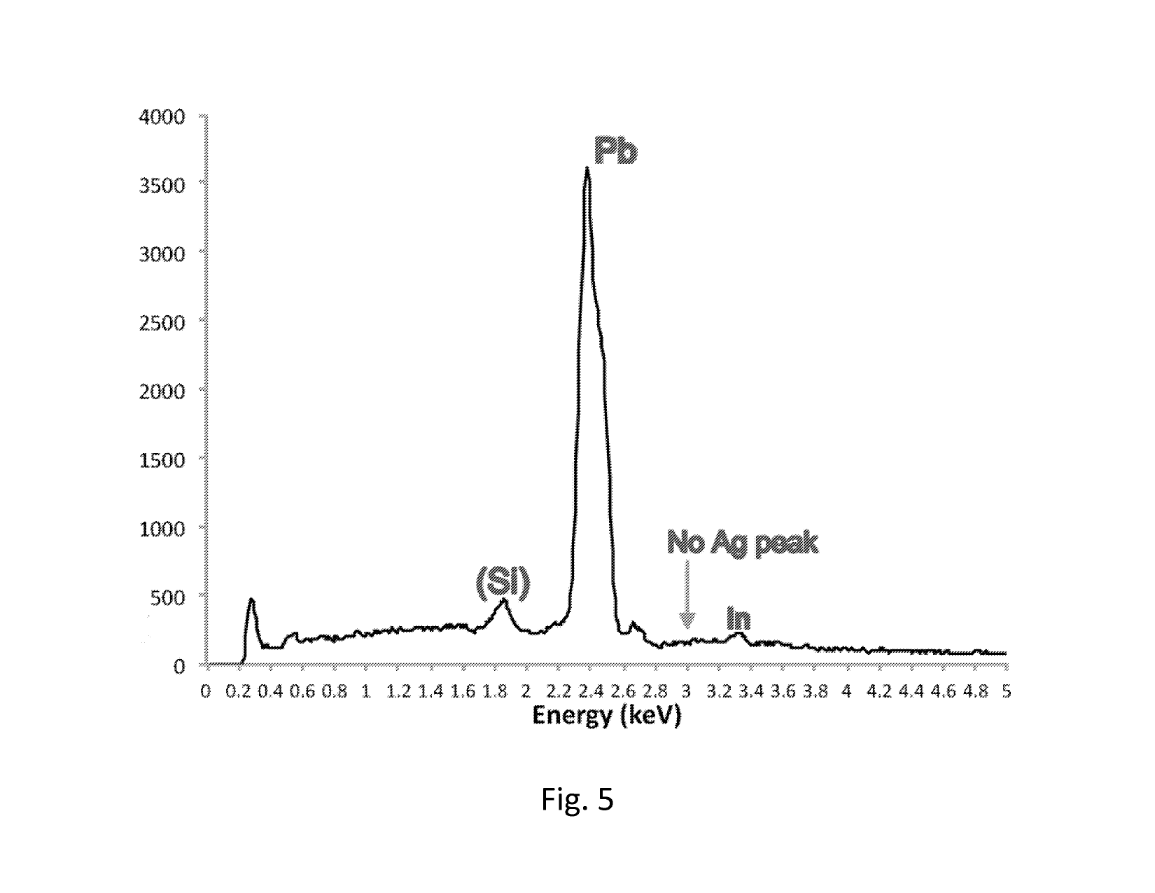

FIGS. 3 and 4 show the microstructure of Pb-5In-2.5Ag in an as-cast form and after annealing at 250° C. FIG. 5 shows an X-ray diffraction study of Pb-5In-2.5Ag, showing an indium enriched band formation which is not seen in the corresponding alloy Pb-5Sn-2.5Ag (see FIG. 1F). The diffraction data reveal no Ag peak. Ag₉In₄ precipitates are observed.

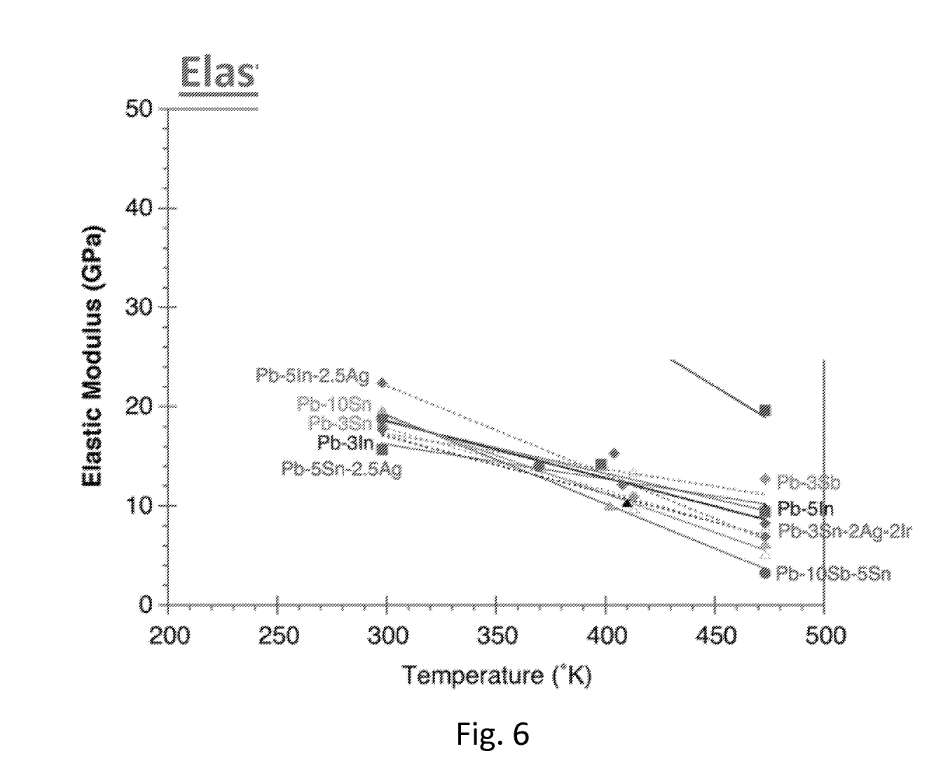

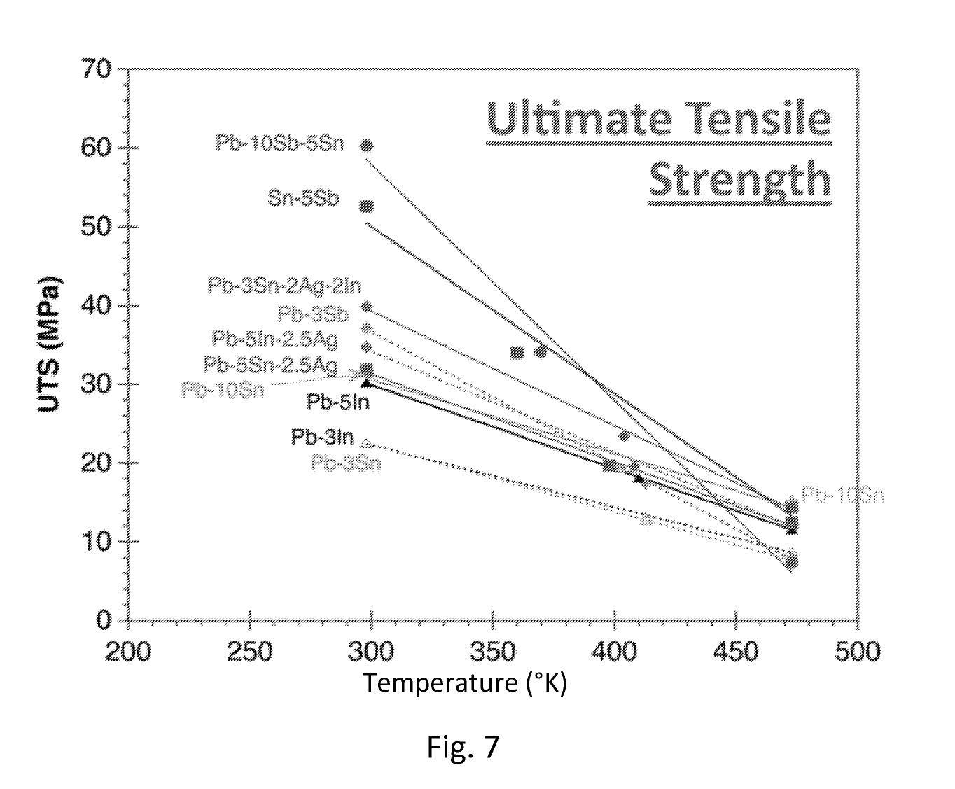

FIGS. 6 and 7 shows the elastic modulus and ultimate tensile strength of Sn-5Sb and various Pb solder alloys as a function of temperature.

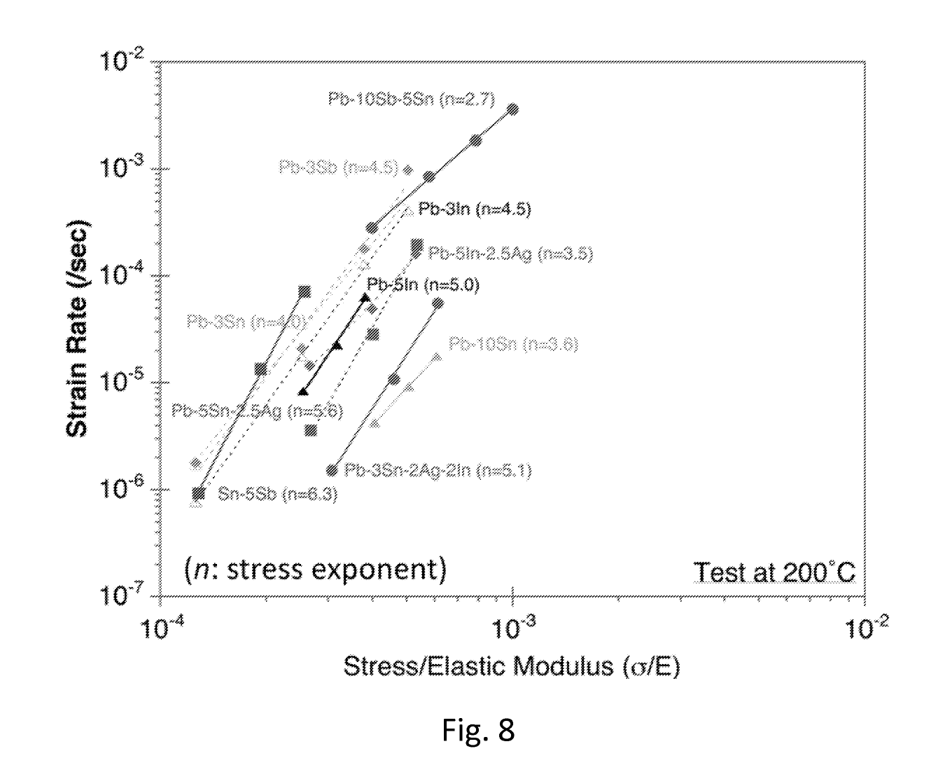

FIG. 8 shows the stress-strain relationship at 200° C. of 95Sn-5Sb and the various Pb solder alloys as a function of temperature. The Pb binary alloys (high MP) tend to have poor strength. Pb—Sn—Ag—In performs well for strength. Pb-10Sn performs well for high temp strength. Pb—In performs poorly for strength (due to large GS). Sn-Sb performs well until 200° C.

Ternary and quaternary alloys (93Pb-2Sn-2Ag-2In) display high creep resistance over the entire temperature range. 97Pb-2Sb has very low creep strain at 25° C., but this is not maintained at 200° C. 90Pb-10Sn has a high creep strain rate at 25° C., but a lowest strain rate at 200° C. This reveals the importance of intermetallic compounds and solid solution for high temperature properties.

The dislocation creep is characterized by the following formula

$${\dot{ɛ}}_{dislocation creep} = A \cdot {( \frac{σ}{E} )}^{n} exp ( - \frac{Q}{RT} )$$

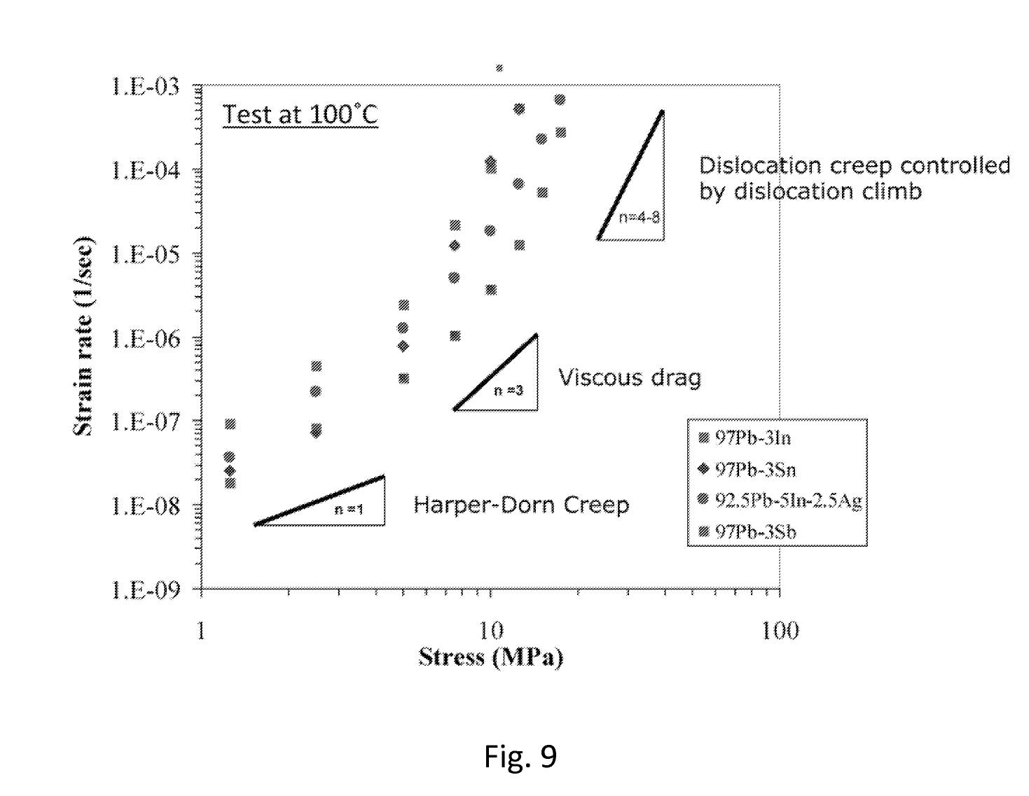

FIG. 9 shows the stress-dependence of creep for various high Pb solder alloys, segregated into regions of Harper-Dorn creep (n=1), viscous drag (n=3), and dislocation creep (n=4-8) controlled by dislocation climb, at 100° C. This graph reveals that the mechanism changes with applied stress, and appears to be correlated with activation energy measurements for Pb-self diffusion.

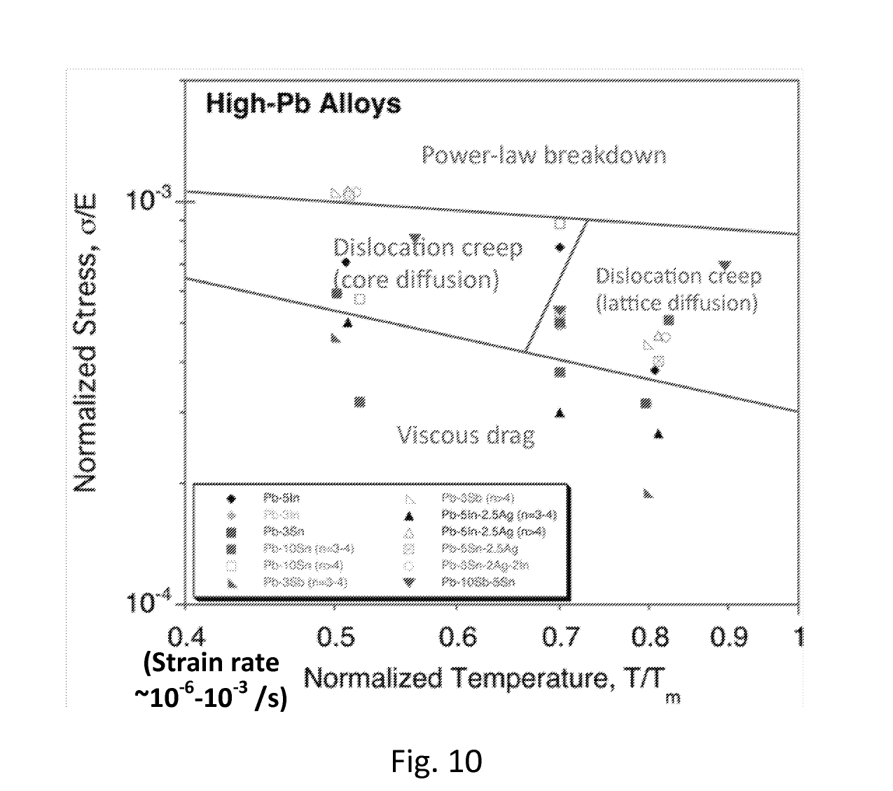

FIG. 10 shows the normalized stress versus temperature for high Pb solder alloys, segregates into regions of viscous drag, dislocation creep (lattice diffusion), dislocation creep (core diffusion), and power-law breakdown with a strain rate of ˜10⁻⁶ to 10⁻³/s.

Dislocation creep appears to be controlled by dislocation climb, and follows the below formulae for core and lattice, respectively, where n is between 4 and 6:

$${\dot{ɛ}}_{dc} = B \cdot {( \frac{σ}{E} )}^{n + 2} exp ( - \frac{{Q}_{core}}{RT} )$$

$${\dot{ɛ}}_{dc} = B \cdot {( \frac{σ}{E} )}^{n} exp ( - \frac{{Q}_{lattice}}{RT} )$$

Creep controlled by viscous dislocation glide follows the below formula:

$${\dot{ɛ}}_{glide} = A \cdot {( \frac{σ}{E} )}^{3} exp ( - \frac{{Q}_{glide}}{RT} )$$

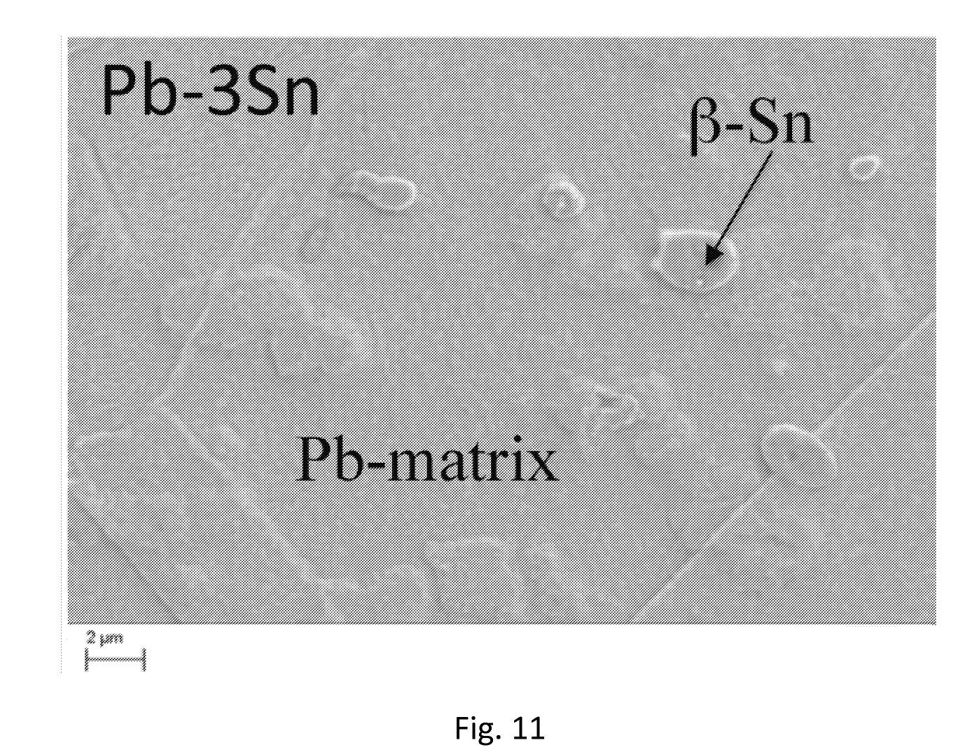

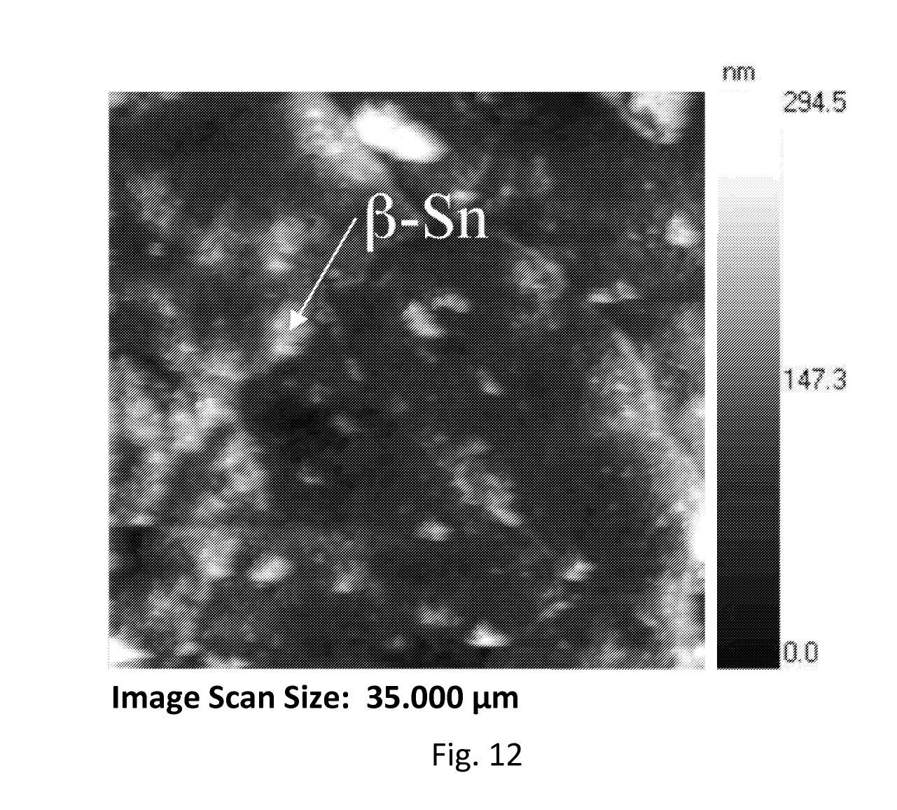

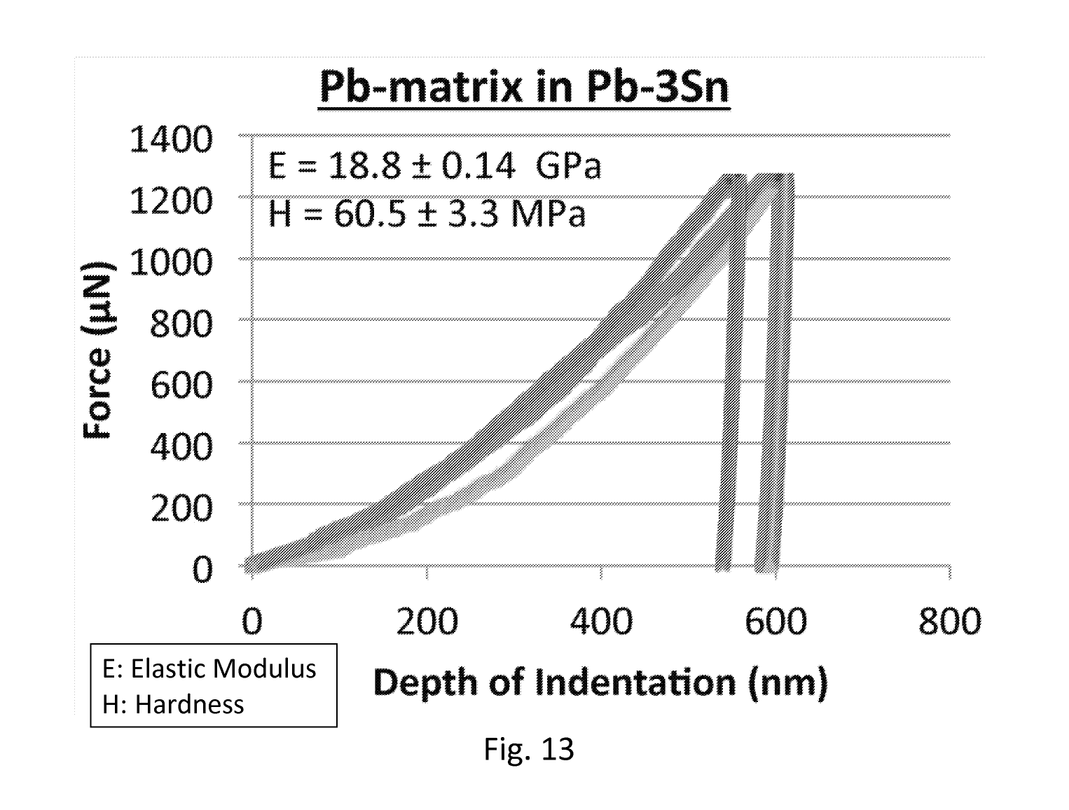

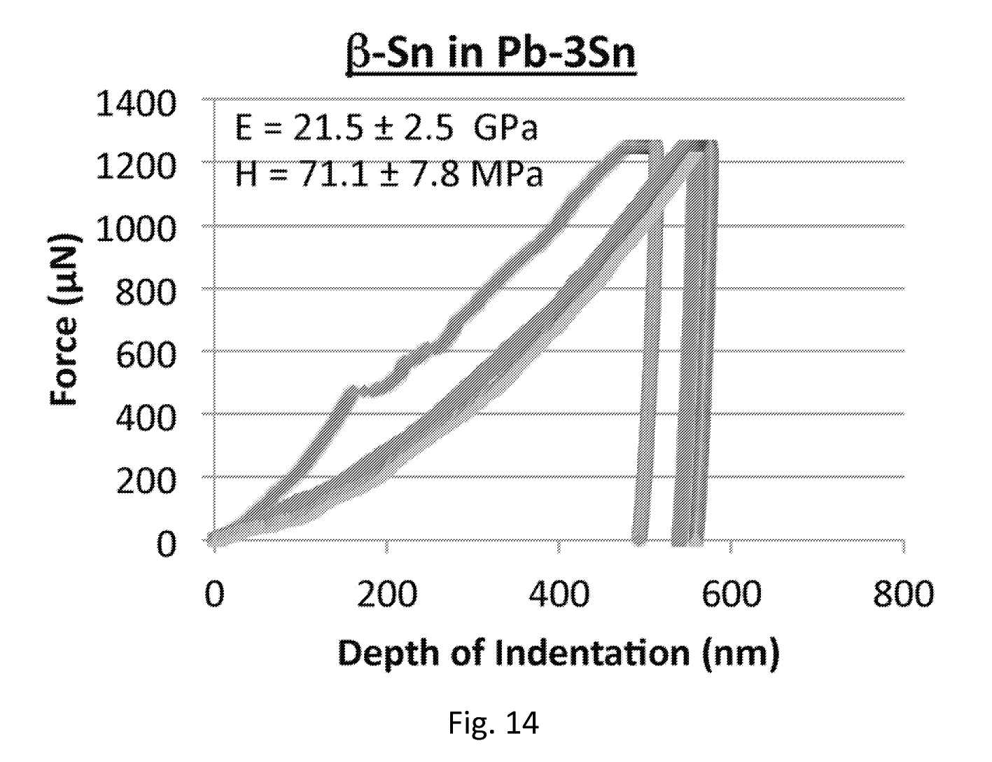

FIGS. 11-12 show the microstructure of Pb-3Sn, showing β-Sn phases in a Pb matrix, and FIGS. 13-14 shows a nano-deformation test of the Pb matrix and β-Sn phases of Pb-3Sn.

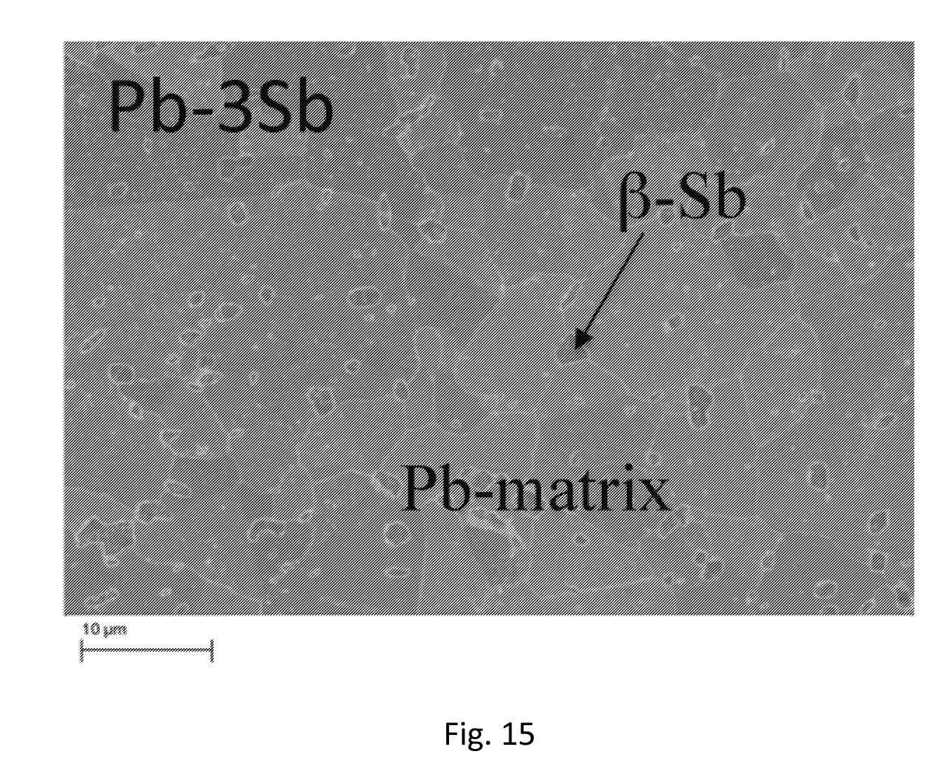

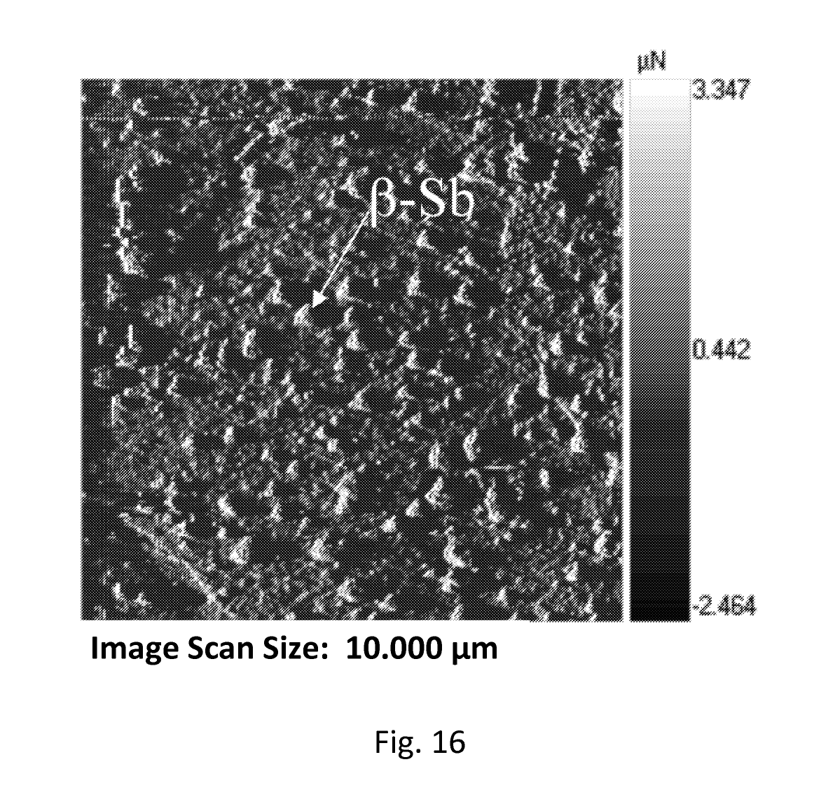

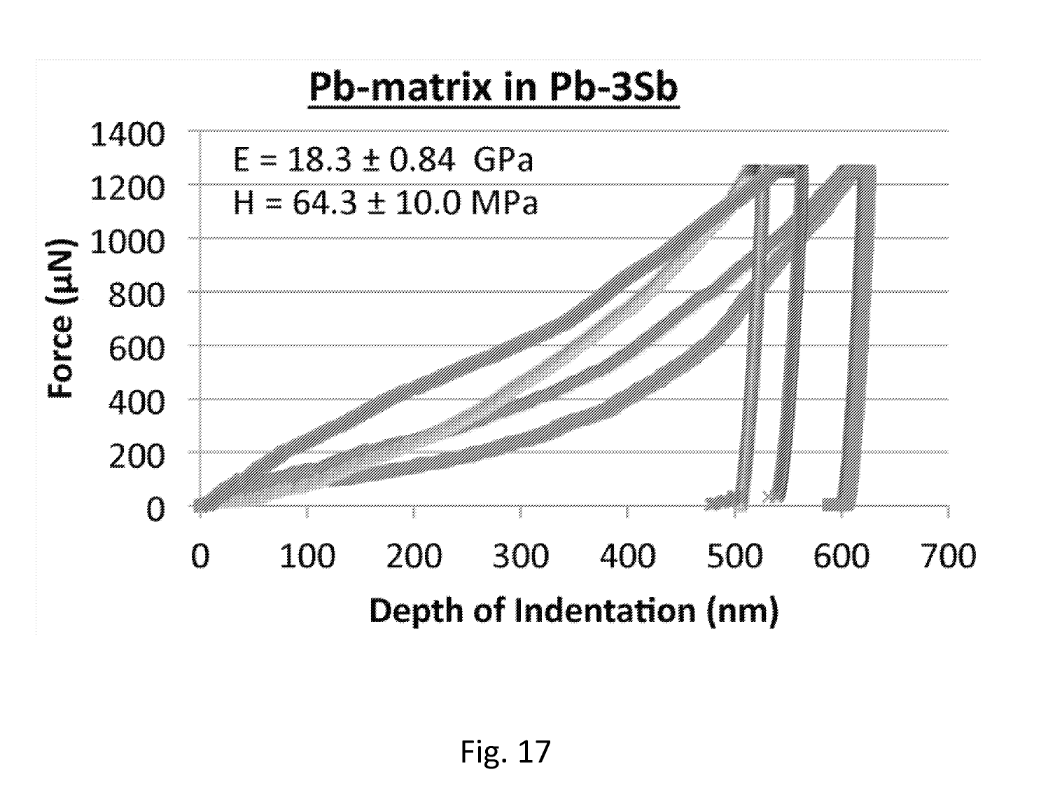

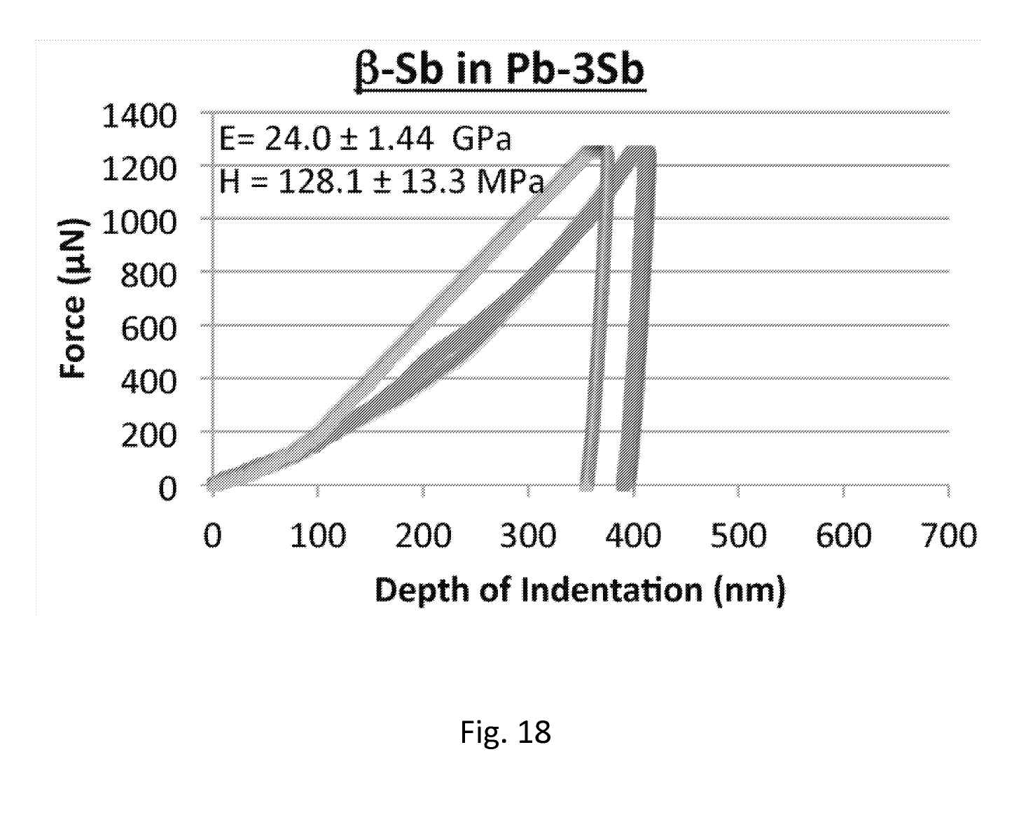

FIGS. 15-16 show the microstructure of Pb-3Sb, showing β-Sb phases in a Pb matrix and FIGS. 17-18 shows a nano-deformation test of the Pb matrix and β-Sb phases of Pb-3Sb. Note that the β-Sb is harder than β-Sn.

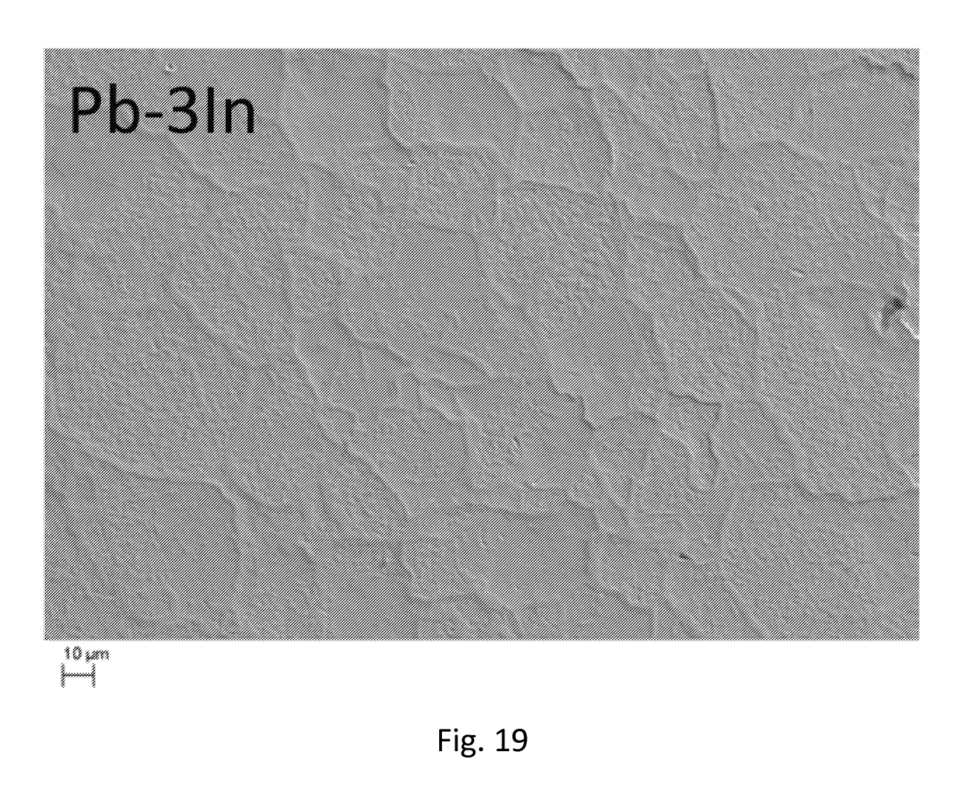

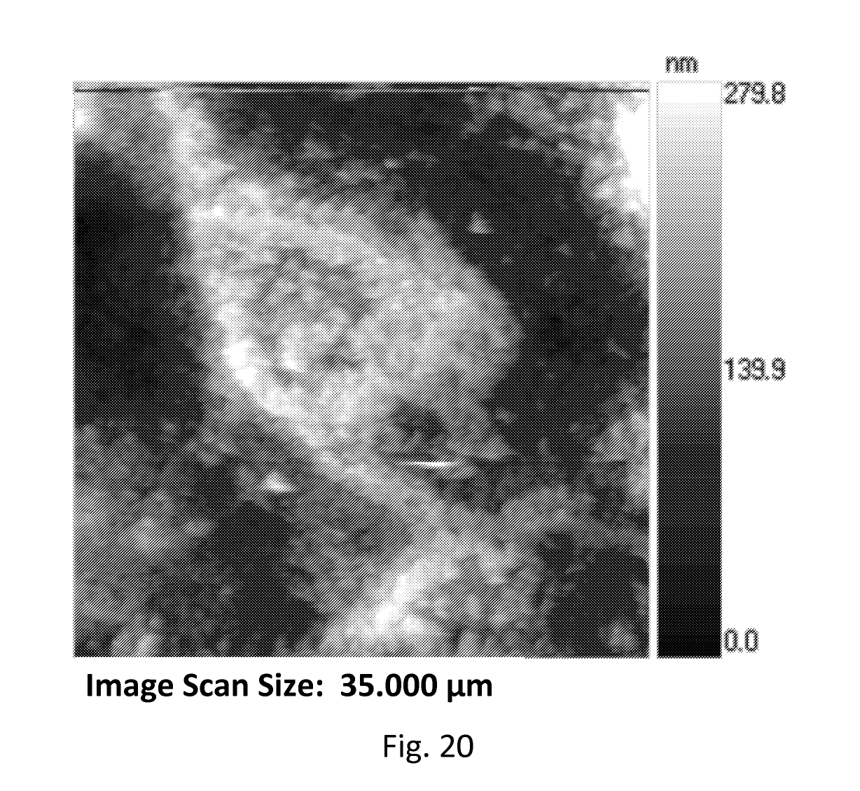

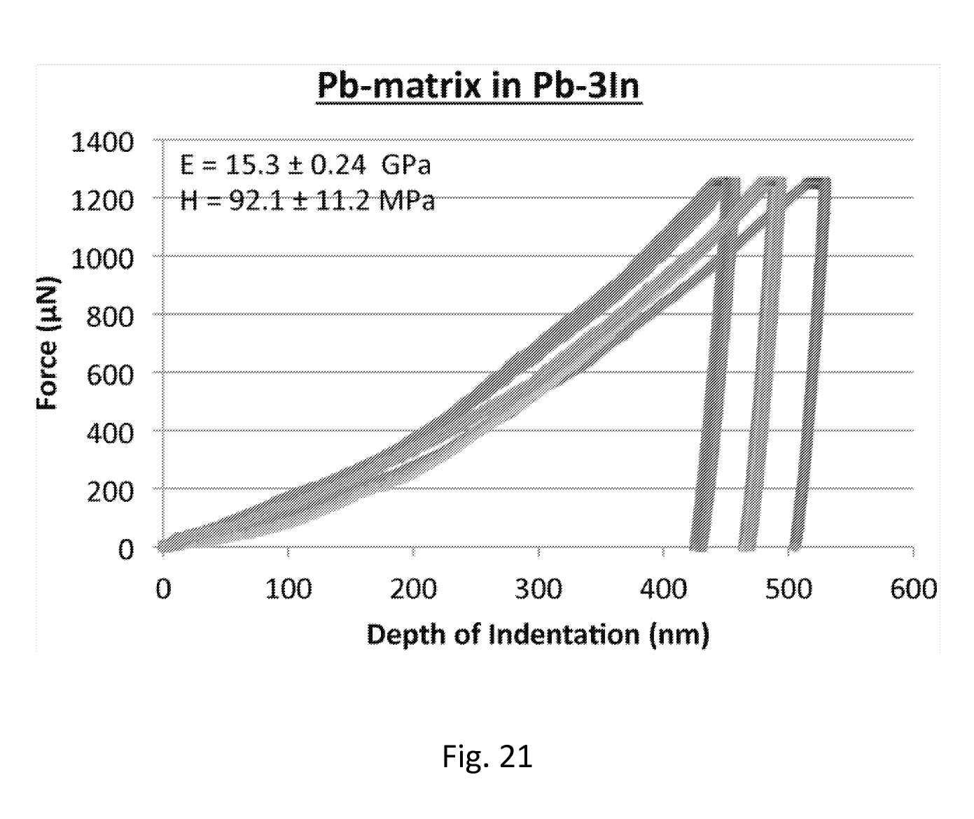

FIGS. 19-20 show the microstructure of Pb-3In, revealing no apparent second phase in the Pb matrix, and FIG. 21 shows a nano-deformation test of the Pb matrix of Pb-3In. Note that the single-phase alloy is harder than the Pb matrix of either 97Pb-3Sn or 97Pb-3Sb. FIG. 21 shows a solid solution resulting in low elastic modulus, but high hardness.

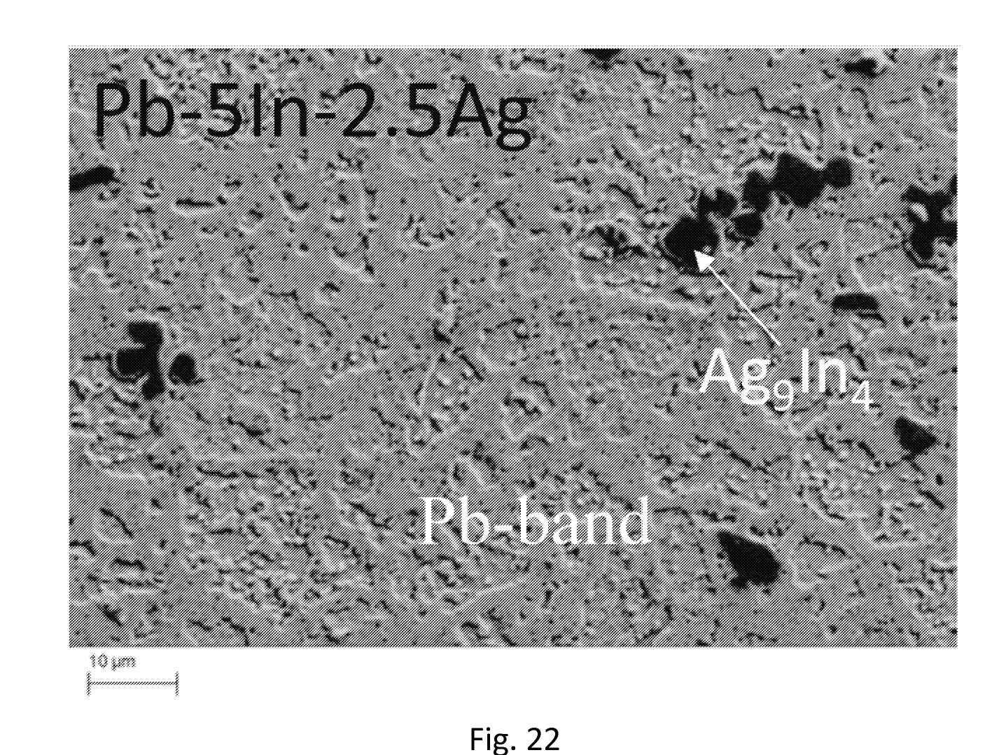

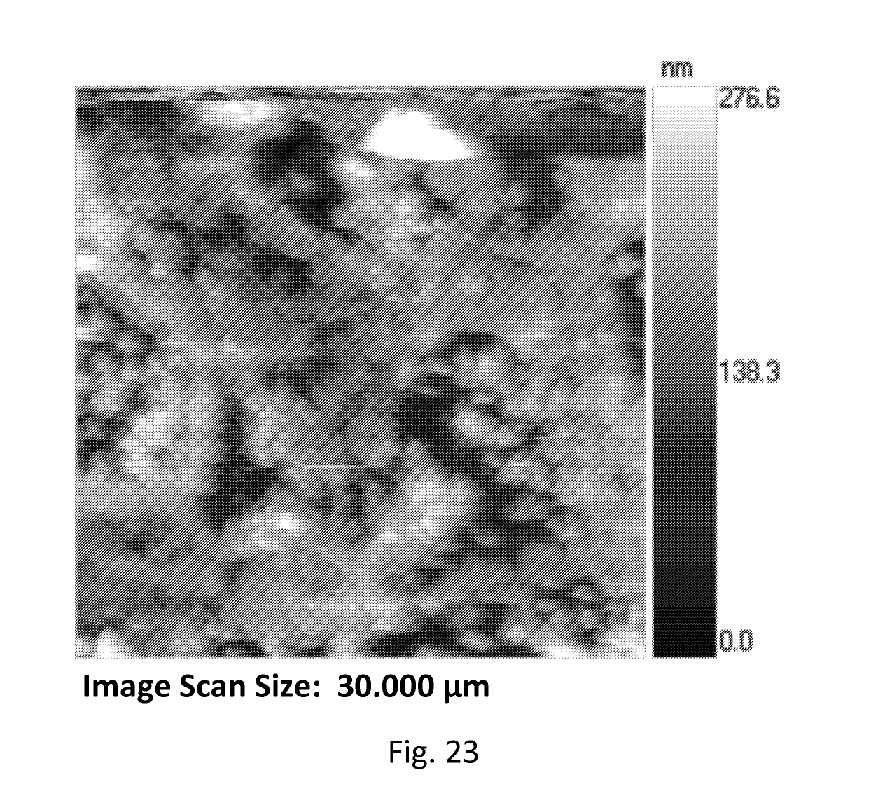

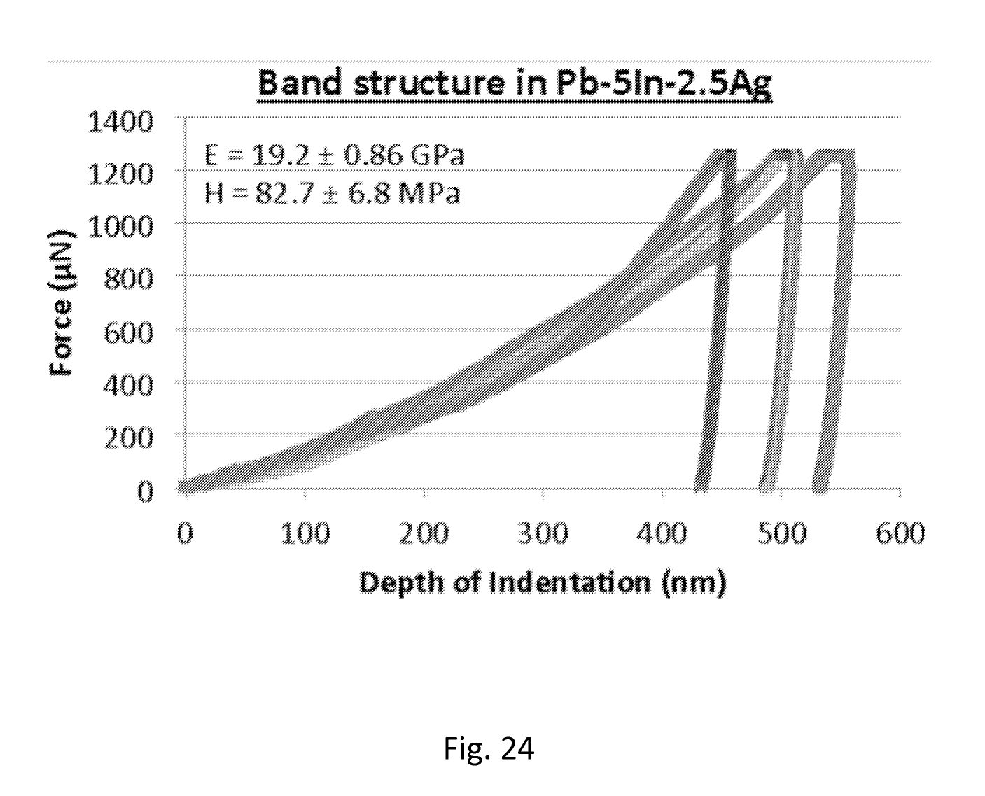

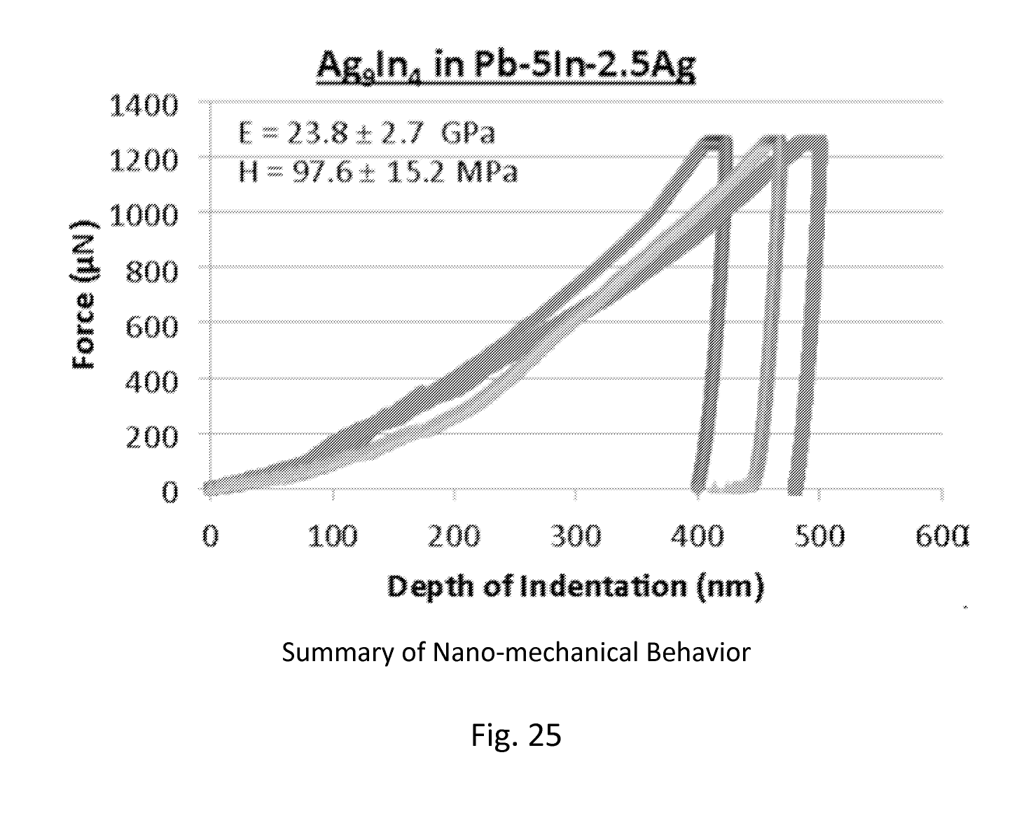

FIGS. 22-23 show the microstructure of Pb-5In-2.5Ag, showing Ag₉In₄ phases in a Pb-band and FIGS. 24-25 shows a nano-deformation test of the Pb band and Ag₉In₄ phases of Pb-5In-2.5Ag. The Pb band has higher elasticity than 97Pb-3In, and an intermediate hardness between 97Pb-3In and 97Pb-3Sn or 97Pb-3Sb.

Table 2 summarizes the nano-mechanical behavior or the high Pb solders.

TABLE 2
Mechanical Properties Comparison

| | | Nanoindentation | | Tensile Testing | |
|---|---|---|---|---|---|
| | | Elastic | Nano- | Elastic | Yield Strength |
| | | Modulus | hardness | Modulus | (0.02% offset) |
| Solders | | (GPa) | (MPa) | (GPa) | (MPa) |
| Pb-3Sn | matrix | 28 ± 1.4 | 172 ± 9.50 | 18.3 | 10 |
| | β-Sn | 36 ± 2.4 | 252 ± 32.0 | | |
| Pb-3Sb | Matrix | 25 ± 1.5 | 162 ± 17.7 | 18.1 | 12.3 |
| | β-Sb | 46 ± 4.2 | 398 ± 32.9 | | |
| Pb-3In | Matrix/band | 23 ± 1.0 | 222 ± 32.9 | 16.1 | 11.8 |
| Pb-5In- | On Crater | 23 ± 1.7 | 273 ± 24.5 | 22.4 | 11.8 |
| 2.5Ag | On Band | 24 ± 2.0 | 238 ± 31.5 | | |
| | On IMC | 39.5 | 1620 | | |
| | (Ag₉In₄) | | | | |
| 78Bi- | On IMC | 70 ± 13.5 | 3500 ± 310 | TBD | TBD |
| 14Cu- | (Cu₃Sn) | | | | |
| 8Sn | Matrix | 21 ± 1.8 | 230 ± 10 | | |
| 70Bi- | On IMC | 90 ± 11.4 | 2200 ± 650 | TBD | TBD |
| 20Sb- | (Cu₂Sb) | | | | |
| 10Cu | Matrix | 58 ± 7.56 | 841 ± 40 | | |

*Yield strength (from tensile testing):
Pb-10Sn: 15.3 MPa;
Pb-5Sn-2.5Ag: 14.3 MPa;
Pb-5In: 11.3 MPa

Pure Bi has: Low thermal and electrical conductivity (vs. Cu), Poor wetting and pad metallurgy (vs. Sn, Zn, Sb), and is brittle (has a duplex microstructure). Properties of various metals used in solder alloys are provided in Table 3.

TABLE 3

| | Bi | Cu | Zn | Sn | Sb |
|---|---|---|---|---|---|
| Crystal | Rhombohedral | FCC | HPC | BCT | Rhombohedral |
| structure | | | | | |
| Melting | 271 | 1083 | 419 | 232 | 630 |
| Point (° C.) | | | | | |
| Toxic | No | No | No | No | High |

Three alloys were modeled, to determine their suitability as high temperature solders: Bi-14Cu-8Sn; Bi-16Cu-10Zn; and Bi-20Sb-10Sn (Tₛ=294° C.; compared to Tₛ for Pb-5Sn-2.5Ag=287° C.).

The microstructure Goals were as follows:

(a) Solid solution (Sb in Bi; compared to Sn and In in Pb);

(b) High-Temperature intermetallic compounds (Cu₃Sn, CuZn, Cu₂Sb); and

(c) Duplex Microstructure (Cu₃Sn—Bi, α-Cu—Bi, Cu₂Sb—Bi).

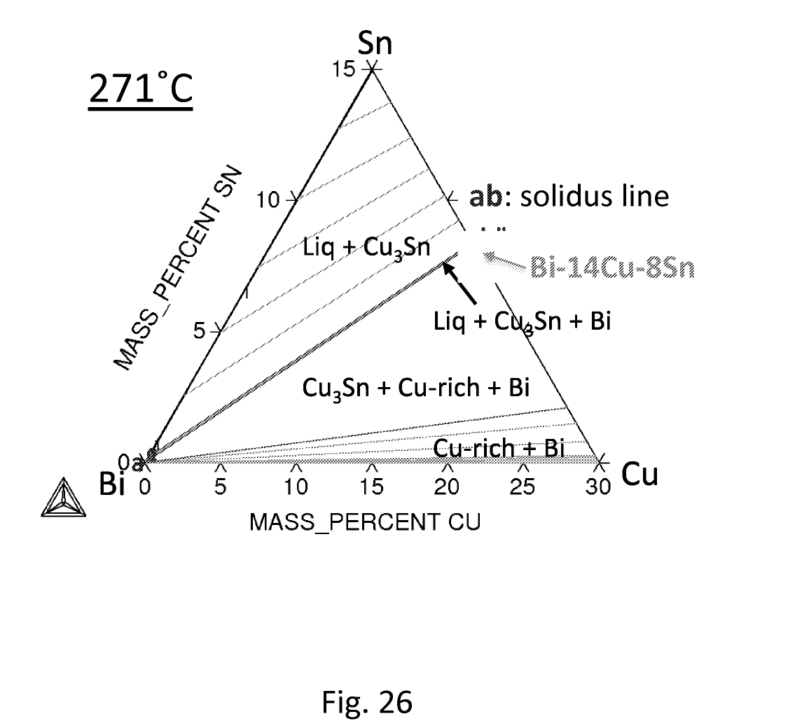

These alloys were modeled using CALPHAD (Thermo-Calc Software), using the TCSLD1 database for: Ag, Al, Au, Bi, Co, Cr, Cu, Ge, In, Ni, Pb, Pd, Pt, Sb, Si, Sn, and Zn. The results of these models are shown in FIGS. 26-29.

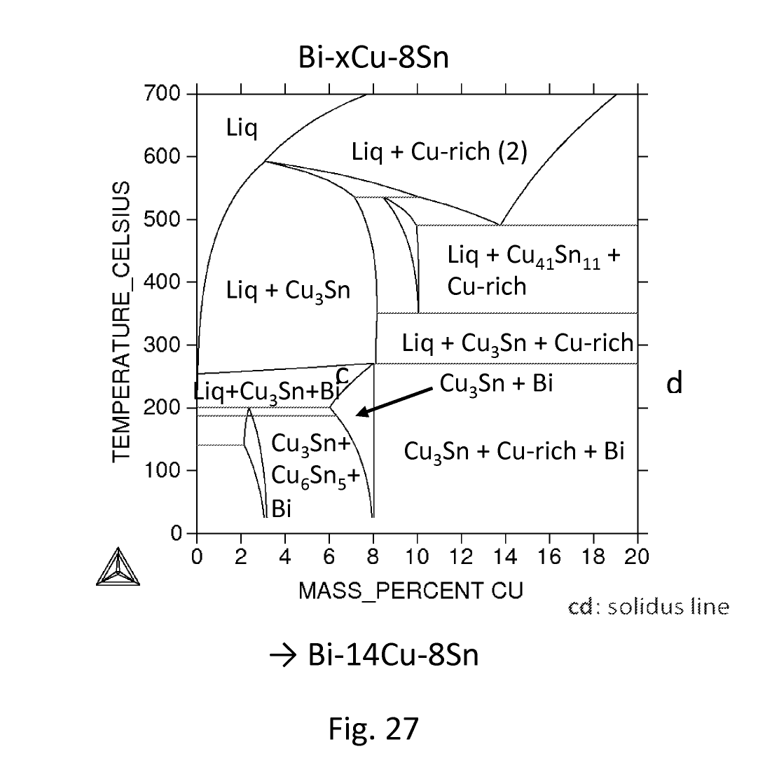

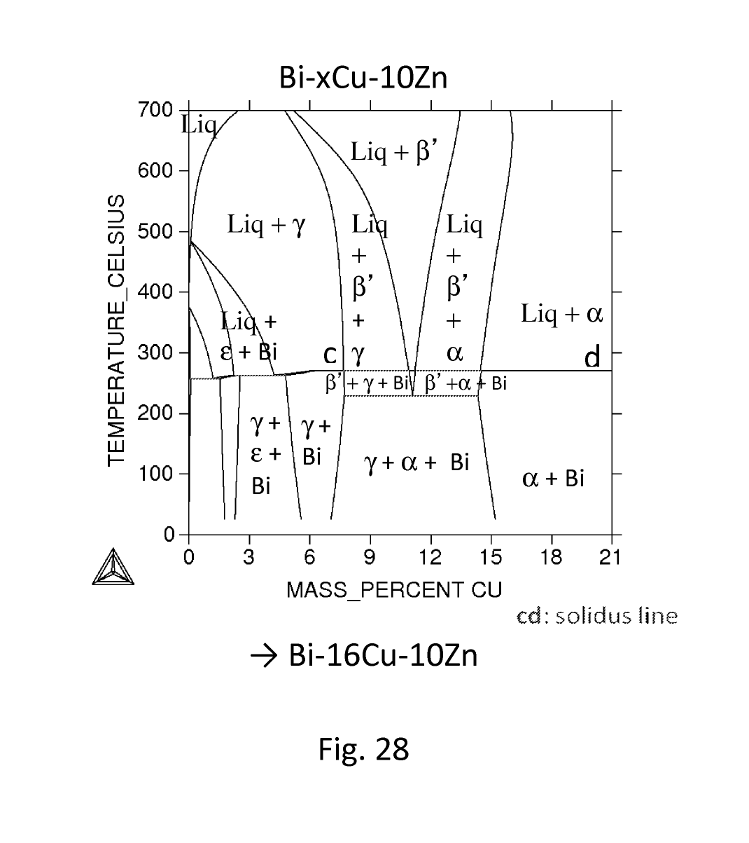

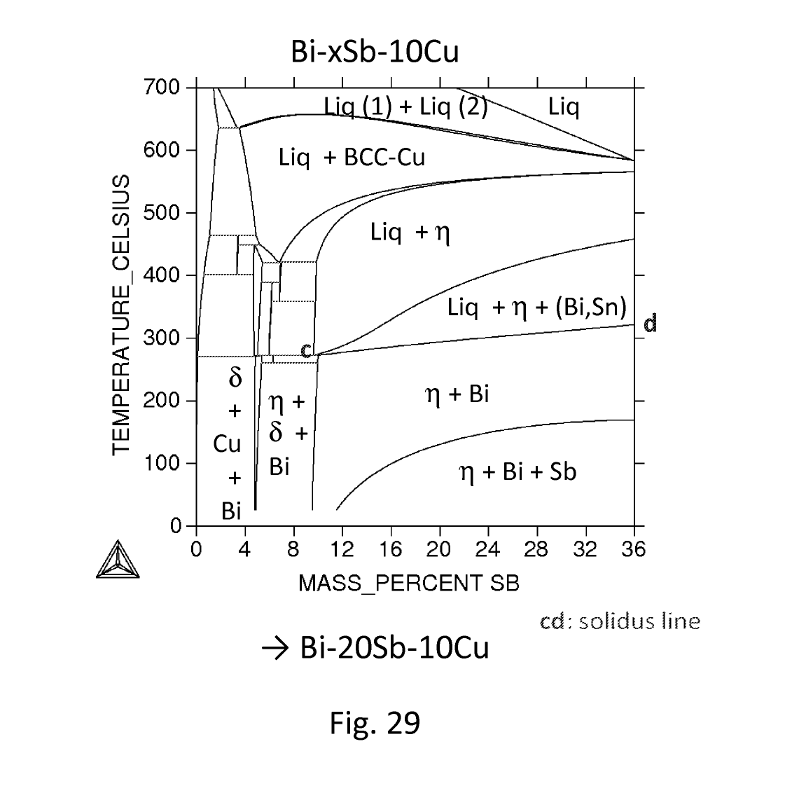

FIG. 26 shows a ternary phase diagram of Bi—Sn—Su, surrounding Bi-14Cu-8Sn. FIG. 27 shows a phase diagram versus temperature of Bi-xCu-8Sn over a range of 0-20% Cu. FIG. 28 shows a phase diagram versus temperature of Bi-xCu-10Zn over a range of 0-21% Cu. FIG. 29 shows a phase diagram versus temperature of Bi-xSb-10Cu over a range of 0-36% Sb.

As shown in FIG. 27, to have a solidus line above 271° C. (c-d), Sn was chosen to be ≦8% for Bi-xCu-ySn, e.g., 81Bi-14Cu-5Sn. According to FIG. 28, the acceptable range of copper is ≧8%, e.g., 8-20% for a solidus at 271° C.

As shown in FIG. 28, to have a solidus line above 271° C. (c-d), Zn was chosen to be 10% for Bi-xCu-10Zn, e.g., 74Bi-16Cu-10Zn. According to FIG. 28, the acceptable range of copper is 8-21 for a solidus at 271° C.

As shown in FIG. 29, to have a solidus line above 271° C. (c-d), Cu was chosen to be 10% for Bi-xSb-10Cu, e.g., 70Bi-20Sb-10Cu. According to FIG. 28, the acceptable range of antimony is ≧9% for a solidus at 271° C.

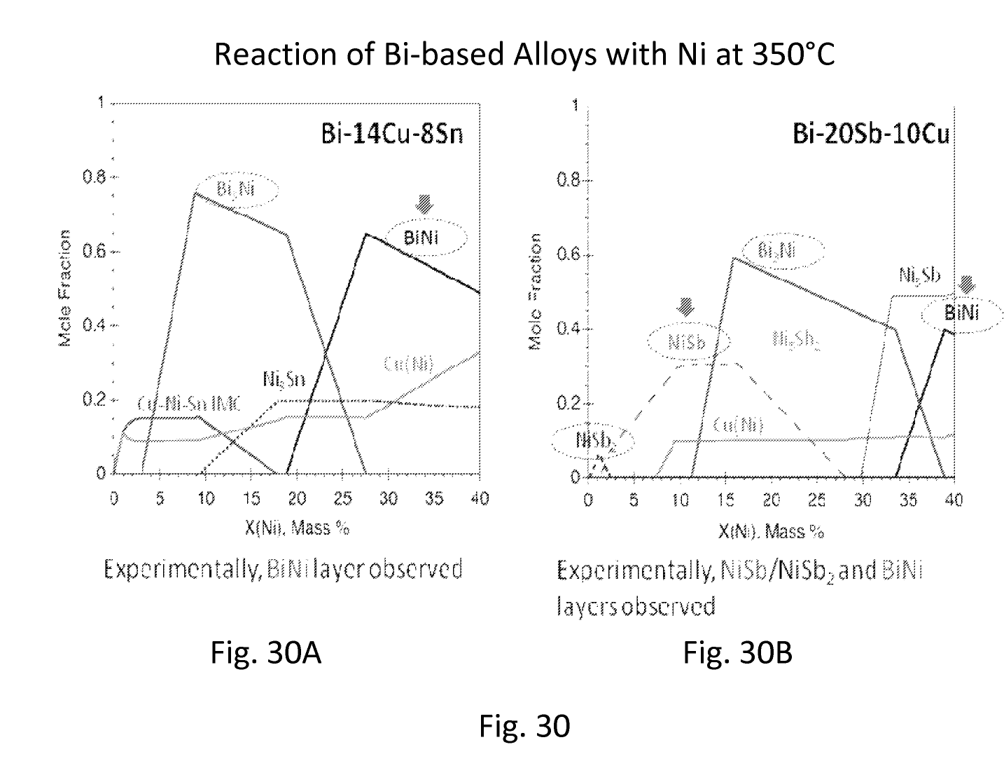

FIG. 30A shows a reaction of Bi-14Cu-8Sn solder at 350° C. with Ni. Experimentally, a Bi—Ni layer is observed. FIG. 30B shows the reaction of Bi-20Sb-10Cu with Ni. Experimentally, a NiSb layer is observed.

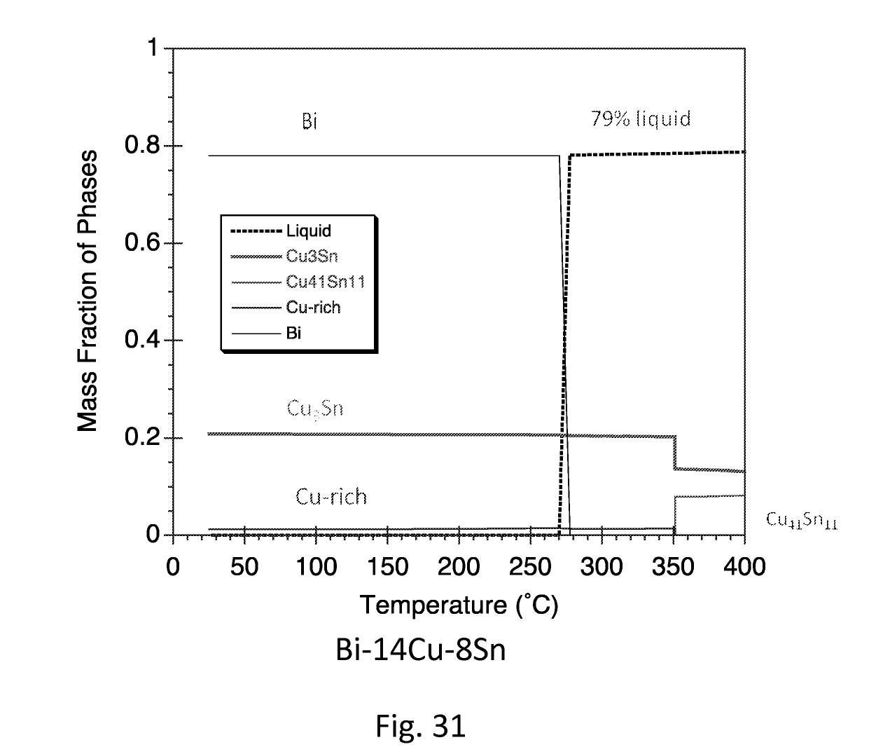

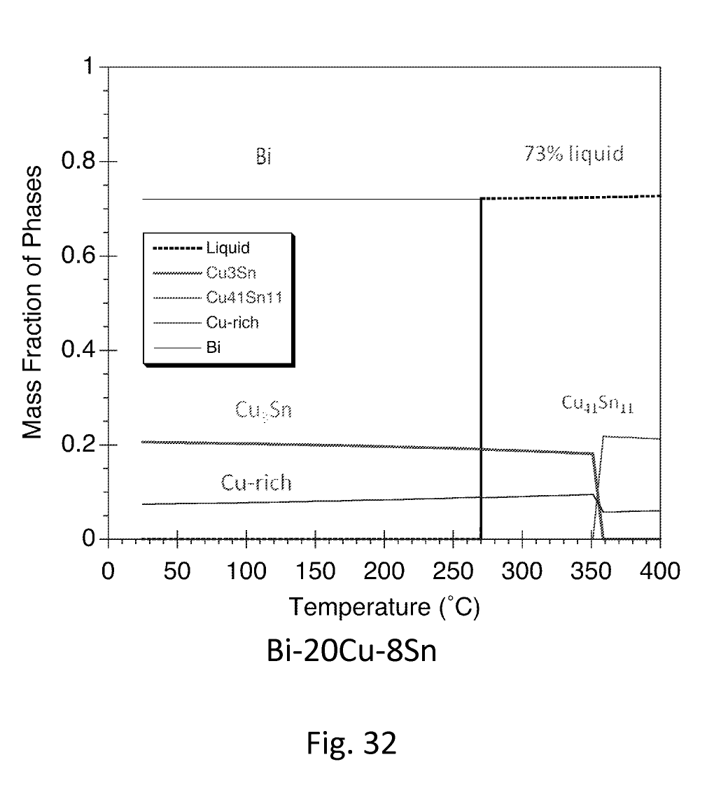

FIGS. 31 and 32 show equilibrium fractions of phases in Bi—Cu—Sn, as a function of temperature for Bi-14Cu-8Sn and Bi-20Cu-8Sn. The thermal conductivity of the components is: Bi (8 W/m·K) Cu₃Sn (70.4 W/m·K), Cu (401 W/m·K). Therefore, the high copper content of the alloy will significantly enhance thermal conductivity. [cf. Pb-5Sn: 31.5 W/m·K, 80Au-20Sn: 58 W/m·K]. The 20% by weight copper alloy has a high mass fraction of a copper-rich component, and above 350° C., a Cu₄₁Sn₁₁ component intermetallic compound.

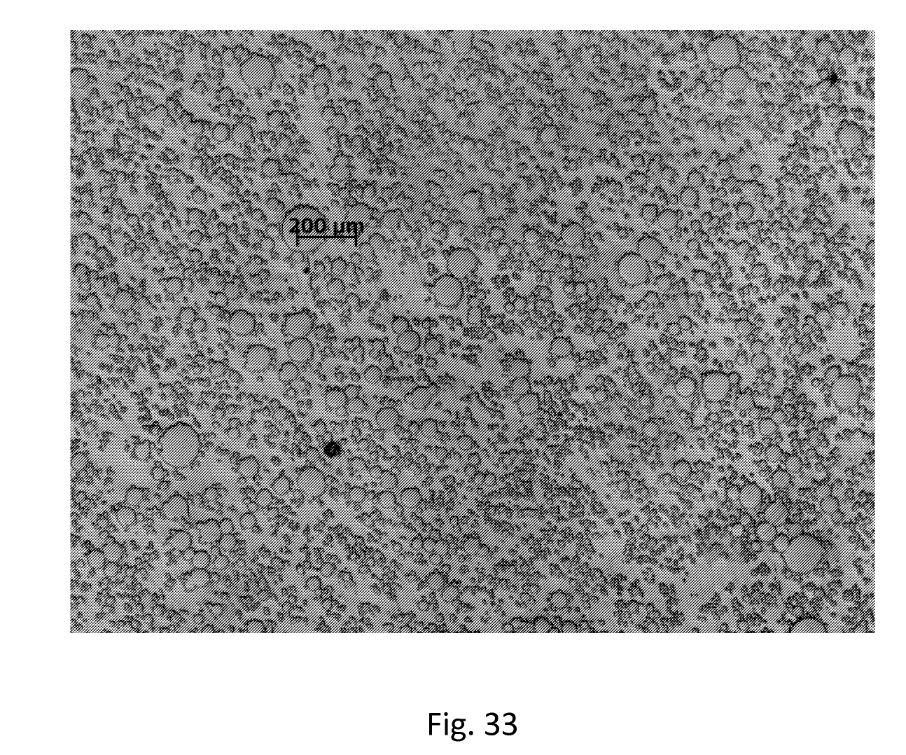

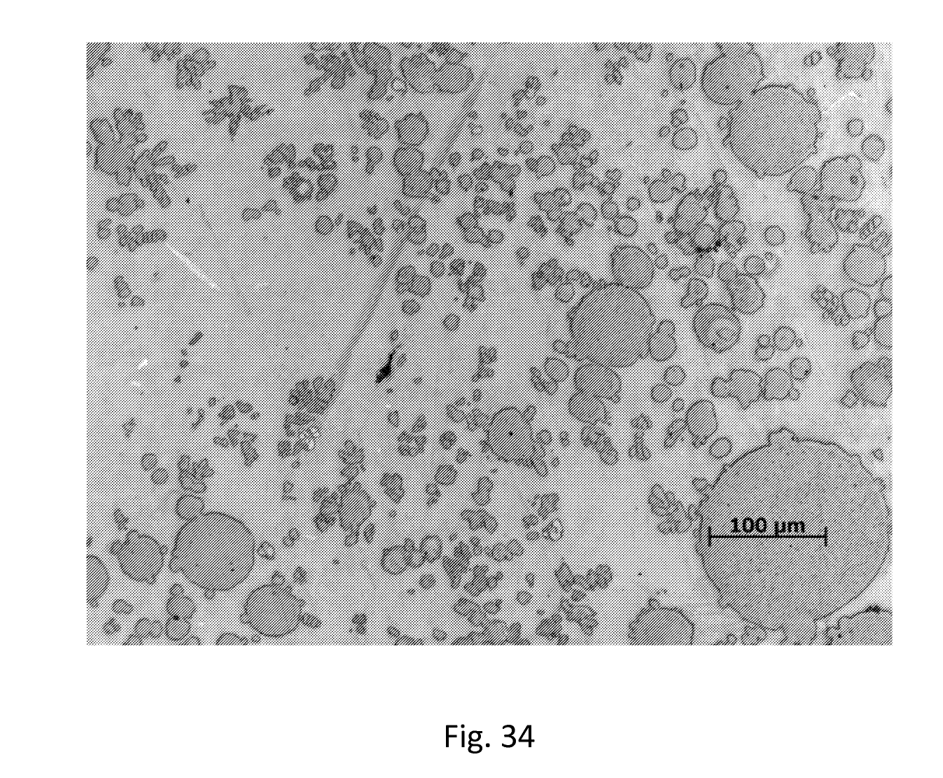

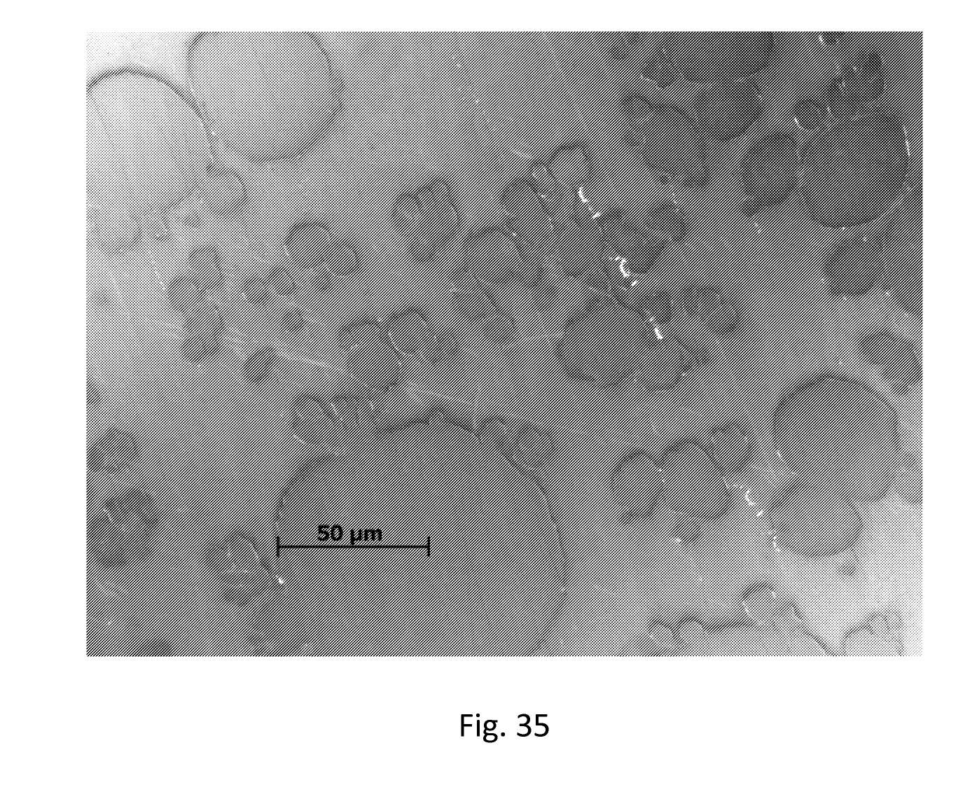

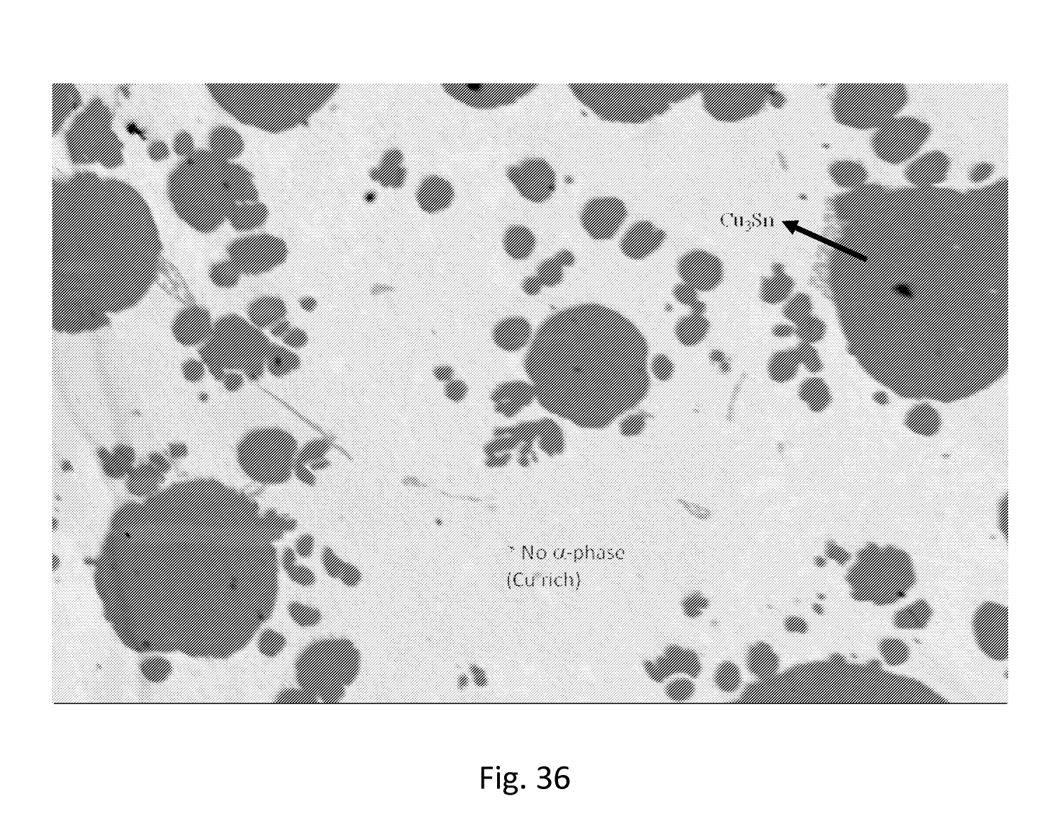

FIGS. 33-36 show optical microscopy (FIGS. 33-35) and scanning electronic microscopy (FIG. 36) images of the microstructure of 78Bi-14Cu-8Sn. These images show that no Cu-rich α-phase is present, and that intermetallic Cu₃Sn particles are present.

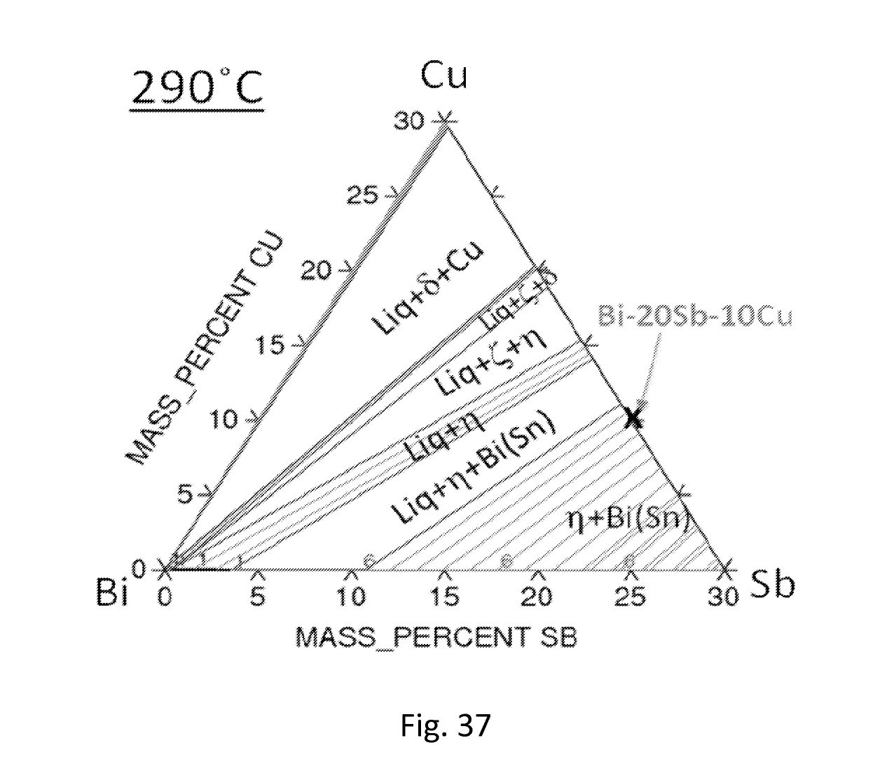

FIG. 37 shows a ternary phase diagram of Bi—Cu—Sb at 290° C. The alloy Bi-20Sb-10Cu falls below, but near the solidus line.

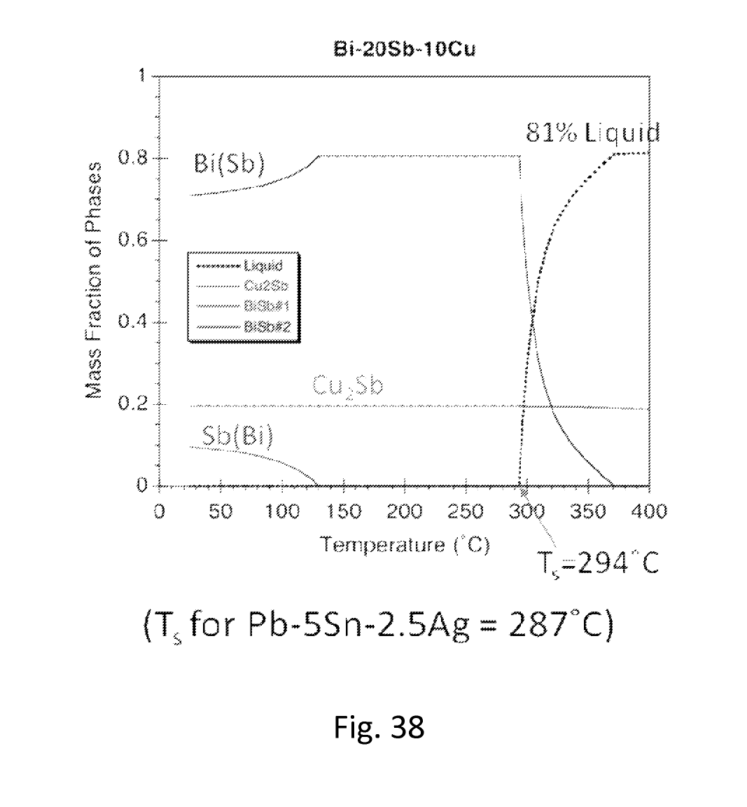

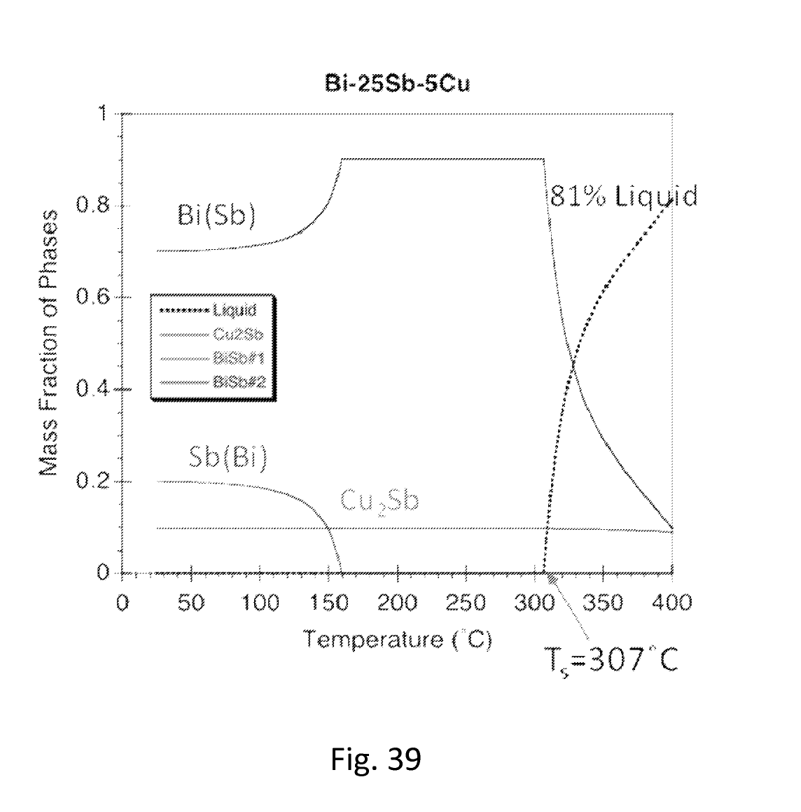

FIGS. 38 and 38 show equilibrium fractions of phases in Bi—Sb—Cu, as a function of temperature for Bi-29Sb-10Cu and Bi-25Sb-5Cu. Thus, by adding more Sb and less Cu, the Tₛ increases from 294° C. to 307° C.

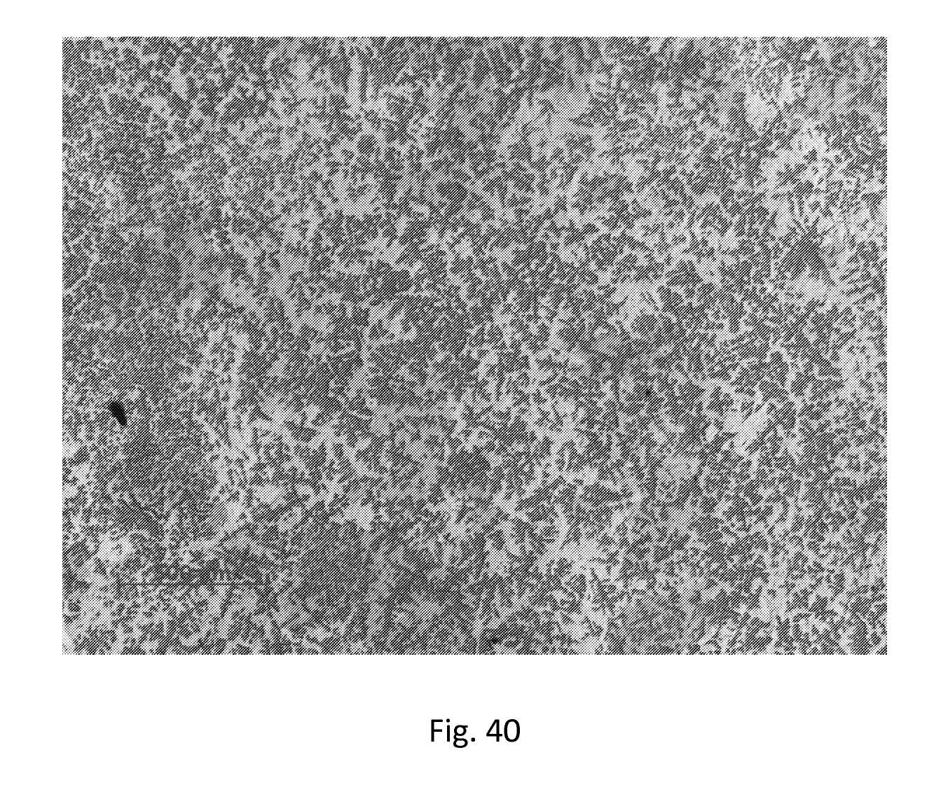

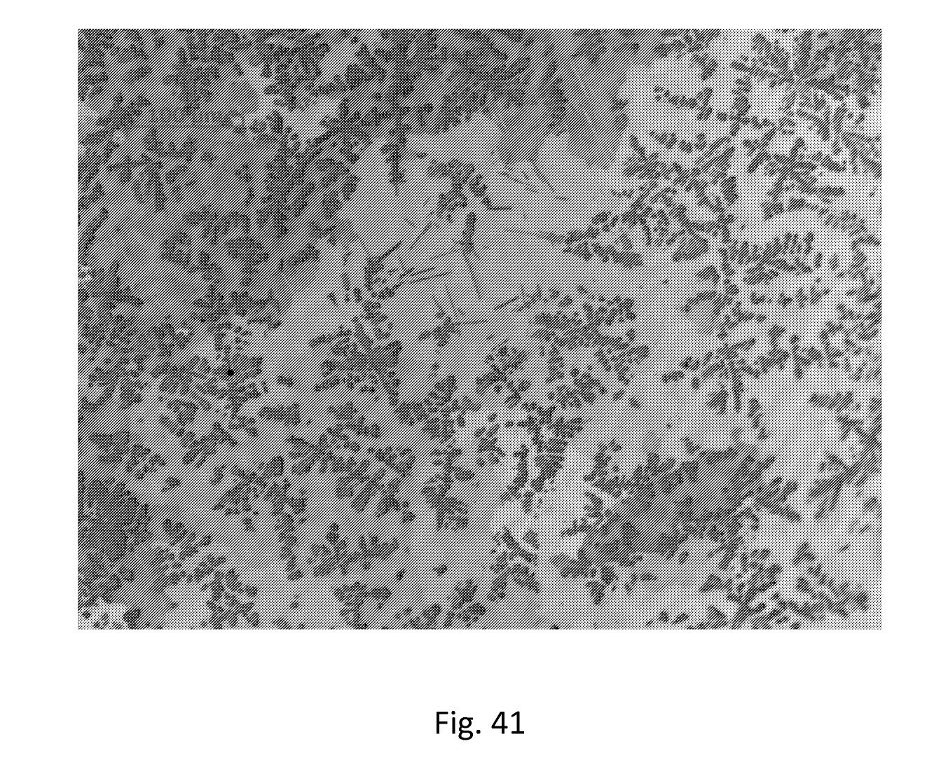

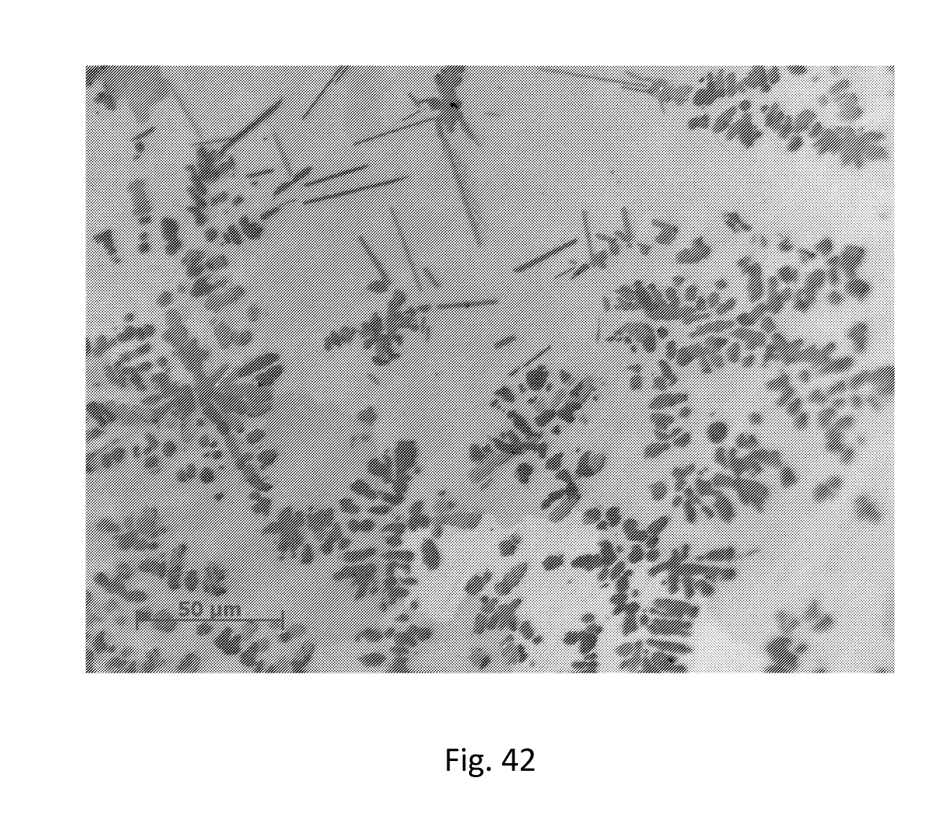

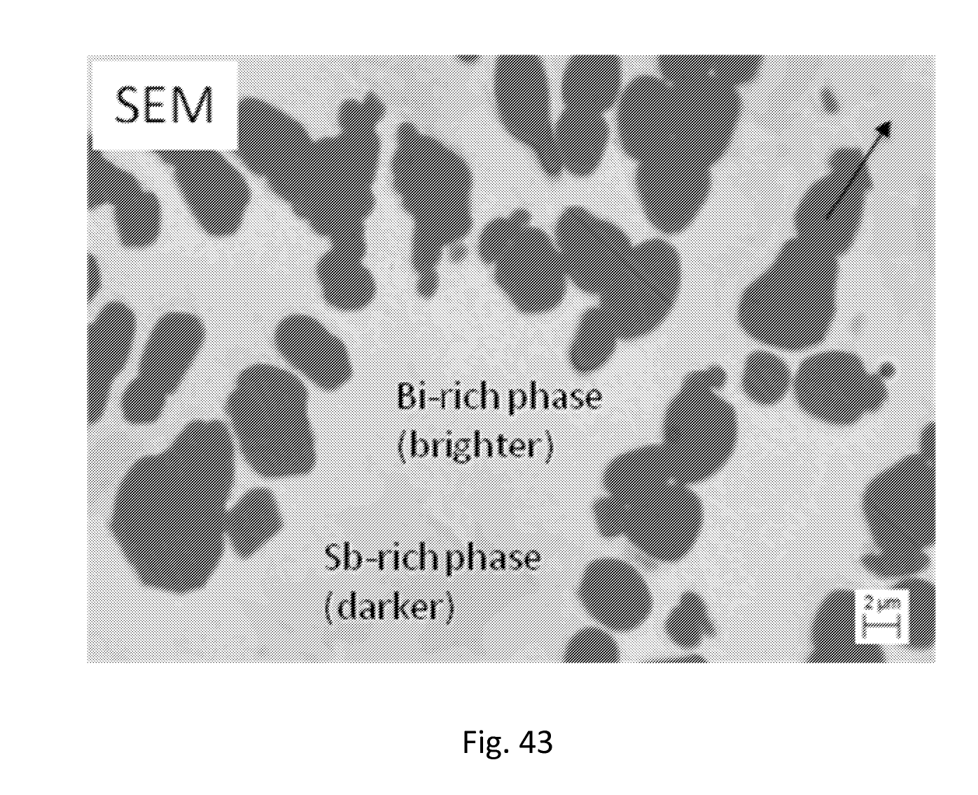

FIGS. 40-43 show optical microscopy (FIGS. 40-42) and scanning electronic microscopy (FIG. 43) images of the microstructure of 70Bi-20Sb-10Cu. The matrix has two regions, a Bi-rich phase (brighter) and a Sb-rich phase (darker). The intermetallic η-phase is composed of Cu₂Sb.

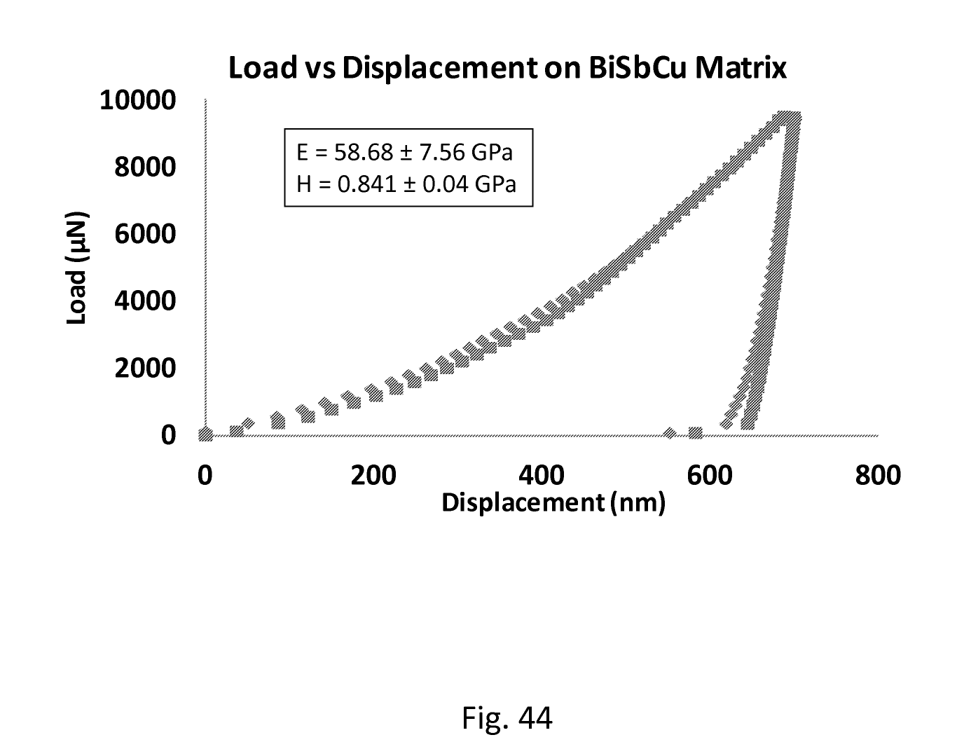

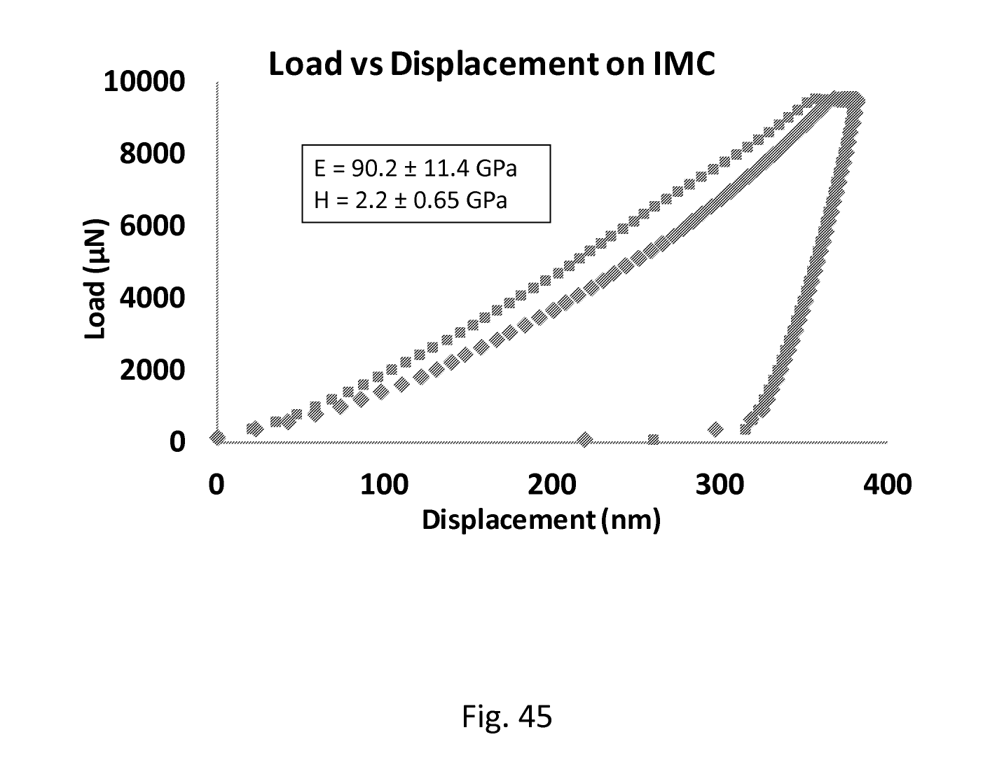

FIGS. 44 and 45 show load vs. displacement diagrams for the BiSbCu matrix (Bi-rich phase) and intermetallic Cu₂Sb compositions for 70Bi-20Sb-10Cu. E represents elastic modulus, and H represents hardness.

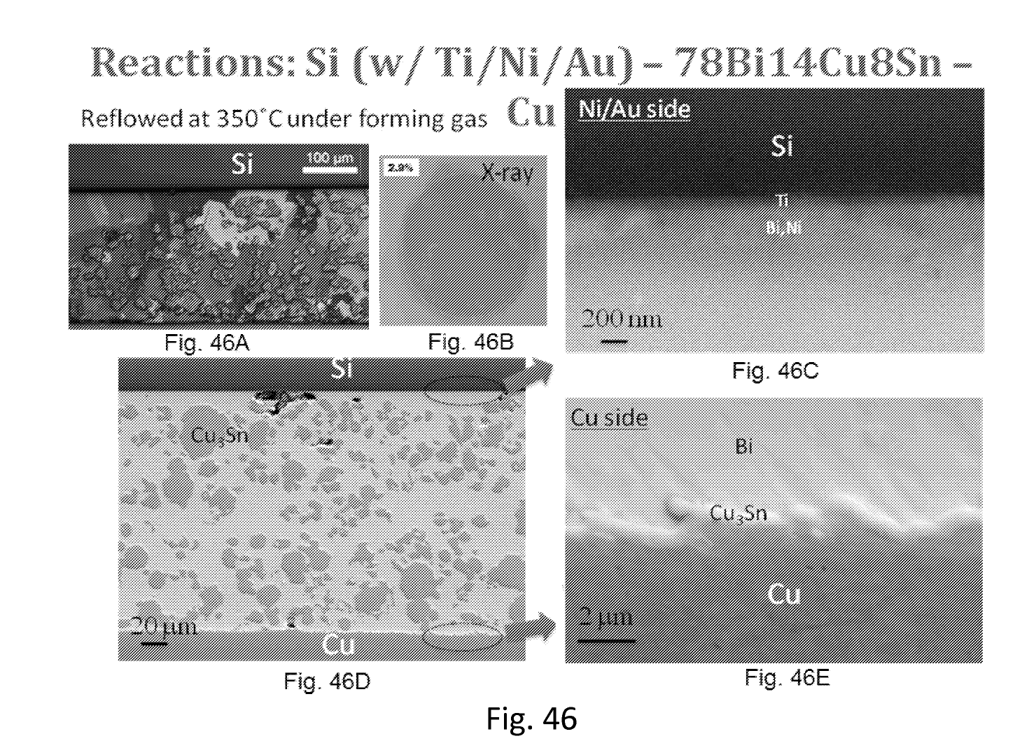

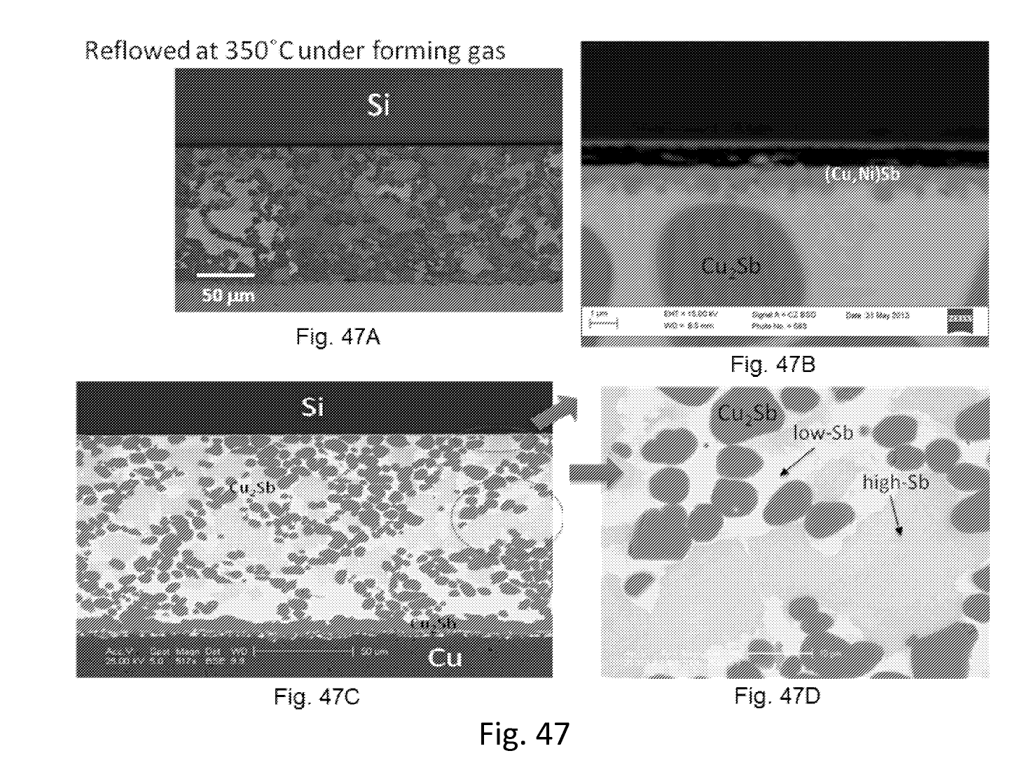

FIGS. 46A-46E show a reaction of silicon (with Ti/Ni/Au) and 78Bi-14Cu-8Sn on copper. FIGS. 47A-47D shows a reaction of silicon (with Ti/Ni/Au) and 70Bi-20Sb-10Cu on copper.

Observations of microstructure mostly confirmed the simulated phase prediction via the Thermo-Calc software. No Cu-rich phase; Cu₃Sn IMC in 78Bi-14Cu-8Sn. Phase separation (high Sb and low Sb) and dendritic Cu₂Sb intermetallic compositions were observed in 70Bi-20Sb-10Cu.

Nanoindentation results showed an increased Elasticity (E) and Hardness (H) for 70Bi-20Sb-10Cu is due to solid solution effect.

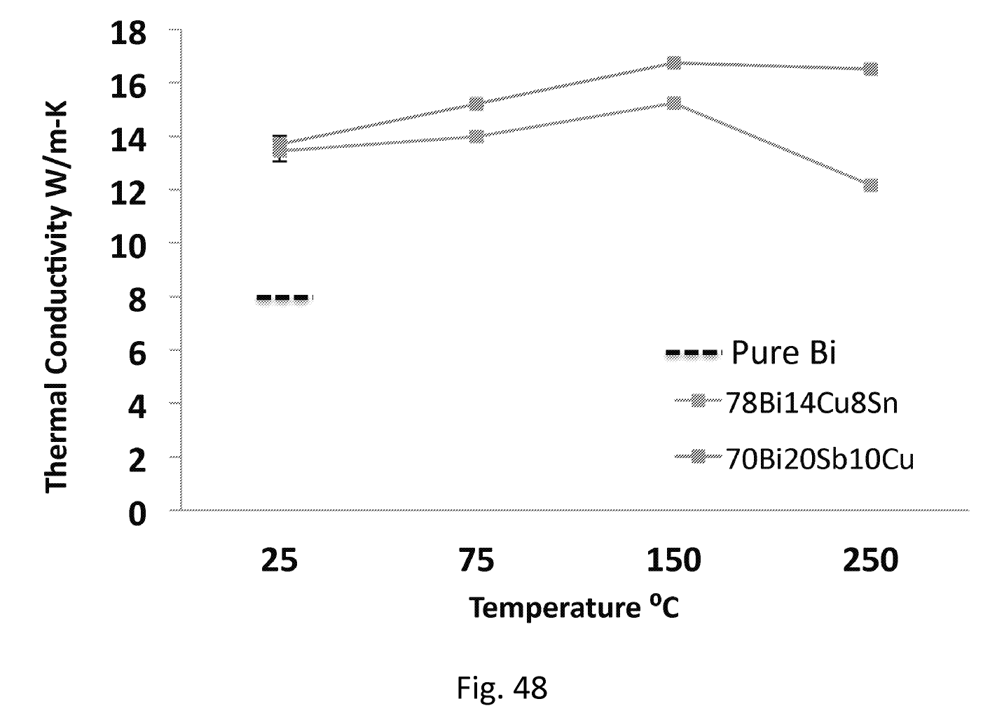

FIG. 48 shows a graph comparing thermal conductivity of 78Bi-14Cu-8Sn, 70Bi-20Sb-10Cu, and Bi. Thermal conductivity of high-Bi alloys is therefore increased compared to pure Bi. The thermal conductivity λ (W/m-K) is proportional to the thermal diffusivity α (m²/s) times density ρ (kg/m³) times the specific heat C (J/kg-K). α is measured from a flash diffusivity apparatus, C is measured by differential scanning calorimetry (DSC), and ρ is calculated by totaling the mass and volume contributions of each element of the alloy.

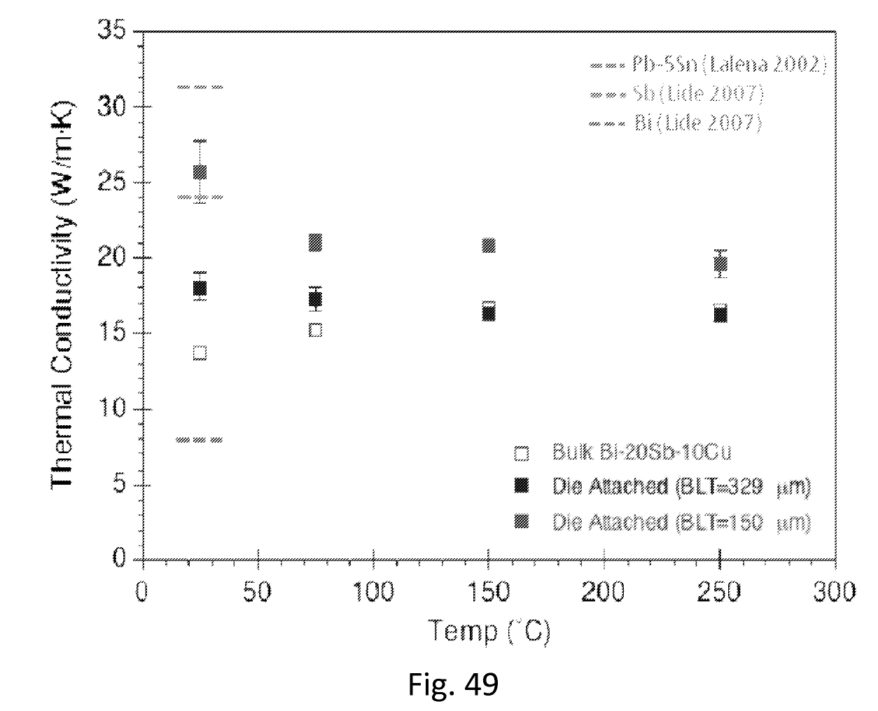

FIG. 49 shows a graph showing thermal conductivity of 70Bi-20Sb-10Cu can further increase with proper microstructure developments at optimum reflow conditions. Thinner BLF (bond line thickness) is achieved through applied pressure during the reflow process.

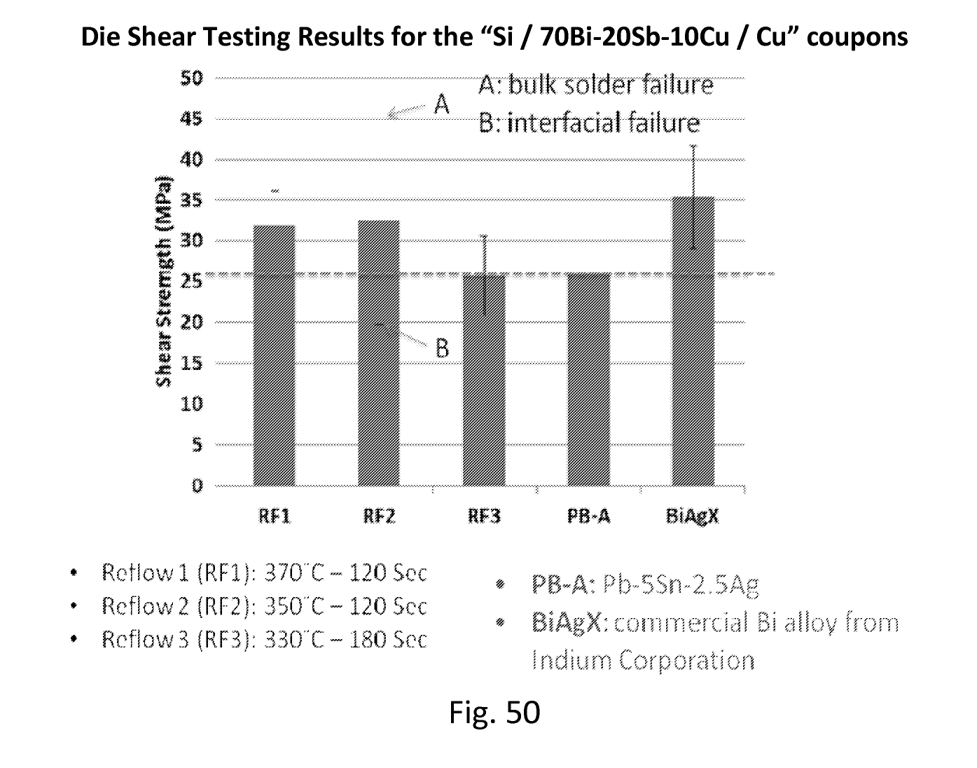

FIG. 50 shows die shear strength results from the sandwiched coupons between the silicon die and the Cu substrate using the 70Bi-20Sb-10Cu solder preform. The data indicate the shear strength can be comparable to or better than the high-Pb based solders.

Reflow on sandwiched coupons shows good reactions with both Ni and Cu. Finer intermetallic compounds (Cu₃Sn, Cu₂Sb) are produced as compared to intermetallic compounds in the as-cast bulk solder; clustered/networked intermetallic compounds (Cu₂Sb) are also observed.

The present technology therefore encompasses ternary solder alloys having bismuth as the principal component, having a solidus temperature between about 250-450° C. (the upper range permitting effective soldering), and including in the solidus phase a Bi matrix or band, an intermetallic phase comprising two metals forming precipitates having a hardness greater than the Bi matrix or band. The alloys preferably are at least 50% Bi. Copper is a preferred component, due to its thermal conductivity, and for example is present in an amount of 8-20% by weight. Zn, Sn and/or Sb are included in an amount of 0.5-36% by weight.

According to one embodiment of the technology, the solder is composed such that in a ternary phase diagram, the main phase of the solidus comprises bismuth, a bismuth alloy, or a bismuth-antimony alloy, with intermetallic inclusions that do not include large amounts of bismuth, e.g., exclude bismuth. On the ternary phase diagram, an amount of a first additional metal of the ternary composition is selected which includes over its range a solidus temperature of at least 271° C., and an amount of the remaining component is added to provide a desired solidus temperature and intermetallic composition precipitates in the solidus.

The composition may also include impurities or quaternary components that do not materially diminish the desired properties.

Each of the above-described embodiments and examples is intended merely to clarify the technical content of the present specification. The invention is not to be construed as being limited to these specific examples, but is to be construed in a broad sense, and may be practiced with various modifications within the spirit and the scope of the claims.

1. A solder comprising:
between about 5-24% copper;
about 4-25% tin or antimony or zinc; and
at least 50% by weight bismuth;
having a solidus temperature of ≧271° C., a reflow temperature of ≦375° C., and at least one intermetallic composition precipitate comprising copper and at least one of tin, antimony and zinc substantially excluding bismuth formed within the solidus phase.

2. The solder according to claim 1, comprising Bi-xCu-8Sn, where x=8-21.

3. The solder according to claim 1, comprising 78Bi-14Cu-8Sn.

4. The solder according to claim 1, comprising Bi-xCu-10Zn, where x=8-21.

5. The solder according to claim 1, comprising 74Bi-16Cu-10Zn.

6. The solder according to claim 1, comprising Bi-xSb-10Cu, where x=9-36.

7. The solder according to claim 1, comprising 70Bi-20Sb-10Cu.

8. A ternary bismuth alloy comprising:
at least 50% bismuth;
5-24% copper; and
4-25% tin or antimony or zinc;
having:
a solidus temperature of ≧271° C.;
a liquidus temperature of ≦660° C.; and
copper intermetallic composition nanoparticles having a hardness greater than the bismuth matrix comprising at least one of tin, antimony and zinc formed within the solidus phase, having a thermal conductivity greater than pure bismuth.

9. The ternary bismuth alloy according to claim 8, comprising Bi-xCu-8Sn, where x=8-21.

10. The ternary bismuth alloy according to claim 8, comprising 78Bi-14Cu-8Sn.

11. The ternary bismuth alloy according to claim 8, comprising Bi-xCu-10Zn, where x=8-21.

12. The ternary bismuth alloy according to claim 8, comprising 74Bi-16Cu-10Zn.

13. The ternary bismuth alloy according to claim 8, comprising Bi-xSb-10Cu, where x=9-36.

14. The ternary bismuth alloy according to claim 8, comprising 70Bi-20Sb-10Cu.

15. A soldering method, comprising:
providing two respective surfaces separated by a gap;
placing a ternary bismuth alloy having a solidus temperature of ≧271° C. within the gap, comprising at least 50% bismuth, 5-24% copper, and 4-25% tin or antimony or zinc, forming at least one intermetallic composition precipitate comprising copper and at least one of tin, antimony and zinc substantially excluding bismuth formed within a solidus phase;
heating the ternary bismuth alloy to a temperature above the solidus temperature, to melt at least a bismuth matrix phase of the ternary bismuth alloy, and wet the respective surfaces with the ternary bismuth alloy; and
reducing the temperature of the ternary bismuth alloy to below the solidus temperature, to solidify the ternary bismuth alloy and thereby join the two metals.

16. The soldering method according to claim 15, wherein the at least one intermetallic composition precipitate comprising copper and at least one of tin, antimony and zinc substantially excluding bismuth formed within the solidus phase comprises copper intermetallic composition nanoparticles having a hardness greater than a bismuth matrix surrounding the nanoparticles, and a thermal conductivity greater than pure bismuth.

17. The soldering method according to claim 15, wherein the ternary bismuth alloy has a liquidus temperature ≦660° C.

18. The soldering method according to claim 15, wherein the ternary bismuth alloy comprises Bi-xCu-8Sn, where x=8-21.

19. The soldering method according to claim 15, wherein the ternary bismuth alloy comprises Bi-xCu-10Zn, where x=8-21.

20. The soldering method according to claim 15, wherein the ternary bismuth alloy comprises Bi-xSb-10Cu, where x=9-36.
